(19) United States
(12) Patent Application Publication
(10) Pub. No.: US 2004/0197433 A1
(43) Pub. Date: Oct. 7, 2004

(54) Film removing apparatus, film removing method and substrate processing system

(76) Inventors: Shouichi Terada, Kikuchi-gun (JP); Naoto Yoshitaka, Kikuchi-gun (JP); Masami Akimoto, Kikuchi-gun (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/831,311

(22) Filed: Apr. 26, 2004

Related U.S. Application Data
(63) Continuation of application No. PCT/JP02/13188, filed on Dec. 17, 2002.

(30) Foreign Application Priority Data
Dec. 17, 2001 (JP) 2001-382885
Dec. 17, 2001 (JP) 2001-382906

(51) Int. Cl. G03C 5/00; B05B 5/00; B28B 17/00

(52) U.S. Cl. 425/174.4; 430/329; 118/639

(57) ABSTRACT

A film removing apparatus comprises a substrate holding portion which holds a substrate having a coating film, a laser source which locally irradiates an alignment mark position of the substrate on the substrate holding portion with laser beams, and partially abrades the coating film from the substrate, a fluid supply mechanism including a main nozzle which supplies a predetermined fluid to the alignment mark position, a recovery mechanism having a suction opening which sucks the predetermined fluid supplied to the alignment mark position together with an abraded film component on the substrate, and a guide member which guides the predetermined fluid emitted from the main nozzle to the alignment mark position, and guides the predetermined fluid and the abraded film component to the suction opening of the recovery mechanism so as not to be diffused/leaked around the alignment mark position.

### CROSS-REFERENCE TO RELATED APPLICATIONS

This is a Continuation Application of PCT Application No. PCT/JPO2/13188, filed Dec. 17, 2002, which was not published under PCT Article 21(2) in English.

This application is based upon and claims the benefit of priority from prior Japanese Patent Applications No. 2001-382885, filed Dec. 17, 2001; and No. 2001-382906, filed Dec. 17, 2001, the entire contents of both of which are incorporated herein by reference.

### BACKGROUND OF THE INVENTION

1. Field of the Invention

The present invention relates to a film removing apparatus which abrades and removes a coating film such as a resist film or an antireflection film from a positioning alignment mark of a substrate, a film removing method and a substrate processing system.

2. Description of the Related Art

In a photolithography process to manufacture an LCD or a semiconductor device, resist application processing to apply a resist solution on a surface of a substrate (an LCD glass substrate, a semiconductor wafer), exposure processing to form a predetermined latent image pattern on a resist film and development processing to develop the resist film are sequentially carried out, and a predetermined circuit pattern is formed on a substrate.

In the exposure processing, a substrate must be very highly accurately positioned with respect to an exposure device. In positioning a substrate, an alignment mark is formed at a predetermined region on the substrate in advance, a position of the alignment mark is detected by using laser beams for position detection, and the positioning is carried out based on the position of the alignment mark. The positioning of the substrate using the laser beams is effective in enabling highly accurate positioning.

Meanwhile, in the resist application step or the antireflection film application step, since a coating film is formed on the entire surface of the substrate by using a spin coating method, the alignment mark is covered with the coating film. Therefore, in the exposure processing step, the alignment mark cannot be correctly detected because the laser beams for positioning are reflected or attenuated by the coating film, and the accuracy of positioning the substrate is degraded, which results in inaccurate pattern exposure.

In Jpn. Pat. Appln. KOKAI Publication No. 10-113779, there is proposed a laser processing apparatus which irradiates a film on an alignment mark with processing laser beams before positioning a substrate with respect to an exposure device, and removes only the film on the alignment mark.

However, the conventional apparatus applies high energy due to laser beams to the film and evaporates and decomposes a component of the film. Therefore, the decomposed film remains and floats along the circumference. If this state is left as it is, floats of the decomposed film again adhere to the substrate, and a normal circuit pattern may possibly not be formed by subsequent processing.

As a means for solving this problem, U.S. Pat. No. 4,752,668 and Jpn. Pat. Appln. KOKAI Publication No. 11-145108 propose a fine processing apparatus which applies boring processing by irradiating a substrate with laser beams in a state that the substrate is soaked in a processing tank having a liquid filled therein. However, even such a fine processing apparatus cannot overcome the possibility that decomposition products of the once removed film may again adhere. It is insufficient to prevent contamination of the substrate. Further, since the liquid adheres to the entire substrate, a cleansing mechanism which cleanses the entire substrate as post-processing is required, which results in a complicated processing step.

### BRIEF SUMMARY OF THE INVENTION

It is an object of the present invention to provide a film removing apparatus which can prevent a substrate from being contaminated when removing a coating film on a predetermined region (alignment mark) on the substrate, a film removing method and a substrate processing system.

A film removing apparatus according to the present invention comprises: a substrate holding portion which holds a substrate having a coating film; a laser source which locally irradiates a predetermined region of the substrate on this substrate holding portion with laser beams and partially abrades the coating film from the substrate; a fluid supply mechanism including a main nozzle which supplies a predetermined fluid to the predetermined region; a recovery mechanism having a suction opening which sucks and removes the predetermined fluid supplied to the predetermined region together with an abraded film component on the substrate; and a guide member which guides the predetermined fluid emitted from the main nozzle to the predetermined region, and guides the predetermined fluid and the abraded film component to the suction opening of the recovery mechanism so as not to be diffused/leaked around the predetermined region.

According to the present invention, the liquid can be emitted onto the substrate, the liquid can be caused to flow on a surface of the substrate, and an operation to remove the film can be performed by emitting the laser beams while recovering the liquid. By doing so, a component of the film decomposed by the laser beams can be taken into the liquid and recovered. Therefore, the film decomposed by the laser beams can be prevented from again adhering to the substrate, thereby avoiding contamination of the substrate. Since the liquid is guided to the predetermined region by the guide member, excessive liquid is not supplied, and the film removing processing can be further efficiently performed. Furthermore, the liquid is not diffused on the entire substrate, and post-processing such as cleansing the substrate can be simplified.

The guide member has a substantially rectangular parallelepiped shape and can be arranged above the predetermined region on the substrate in contiguity with the substrate. A groove to guide the liquid may be formed on a lower surface of the guide member. The liquid can be assuredly guided to the predetermined region by this groove, and the decomposed and abraded film can be appropriately and securely removed from the substrate.

The guide member may be a transparent member through which the laser beams from the laser source are transmitted. As a result, the laser beams cannot be blocked by the guide member, and the predetermined region on the substrate can be appropriately irradiated with the laser beams. Moreover, since the guide member is a transparent member, the predetermined region can be irradiated with the laser beams at any angle, and an attachment position of the laser source can be freely selected.

An oscillator may be disposed to the main nozzle. As a result, vibrations can be propagated to the liquid emitted from the main nozzle, and hence film abrading and removing effects by the liquid itself can be improved. It is to be noted that the oscillator may generate ultrasonic vibrations. Additionally, an outlet of the main nozzle may be directed to the predetermined region on the substrate. As a result, the liquid having vibrations applied thereto directly collides with the predetermined region, thereby further increasing the film abrading and removing effects.

Further, the oscillator may be attached to the guide member, and the oscillator may be disposed to the substrate holding portion. Even in such a case, vibrations are transmitted to the liquid, and the film abrading and removing effects provided by the liquid can be improved.

Furthermore, in a state that the liquid is caused to flow on the predetermined region on the substrate, the film removing operation can be performed by irradiating the predetermined region with the laser beams. Moreover, the liquid which has passed through the predetermined region can be isolated from the substrate by a rectifying plate. As a result, it is possible to prevent the liquid which has encountered the film and been contaminated from again coming into contact with the substrate, and prevent particles of the film from again adhering to the substrate.

Moreover, in a state that a liquid is caused to flow on the predetermined region on the substrate and flows of a fluid having the same direction as that of the liquid are formed on both sides of the flow of the liquid, the film removing operation can be effected by irradiating the predetermined region with the laser beams. As a result, the liquid is sandwiched by the fluid and caused to linearly flow without being diffused on the substrate. Therefore, it is possible to prevent the liquid which has taken the decomposed film therein from being diffused on the entire surface of the substrate and prevent particles of the film from again adhering to the substrate. It is to be noted that the fluid emitted from a sub nozzle may be pure water or a gas.

A film removing apparatus according to the present invention comprises: a substrate holding portion which holds a substrate having a coating film; a laser source which locally irradiates a predetermined region of the substrate on this substrate holding portion with laser beams and partially abrades the coating film from the substrate; and a main nozzle which supplies a predetermined fluid to the predetermined region, wherein the film removing apparatus further comprises: a film removing unit which includes a first suction opening which sucks and removes the predetermined fluid supplied to the predetermined region together with an abraded film component on the substrate, guides the predetermined fluid emitted from the main nozzle to the predetermined region, and guides the predetermined fluid and the abraded film component to the first suction opening so as to prevent them from being diffused/leaked around the predetermined region; a fluid supply mechanism which supplies the predetermined fluid to the main nozzle; and a recovery mechanism which communicates with the first suction opening.

According to the present invention, a film removing space can be formed above the predetermined region by arranging the film removing unit above the predetermined region on the substrate in contiguity with the substrate. Further, since the liquid can be supplied to the film removing space and the liquid can be drained from the film removing space, the film abraded in the film removing space by the laser beams can preferably be discharged together with the liquid. In this case, since the liquid is efficiently supplied into the limited space, a consumption of the liquid can be reduced. Furthermore, since a part of the film removing unit is formed of a transparent member, the laser beams can preferably be emitted without cutting off the laser beams.

To the film removing unit may be provided a supply tube which supplies the liquid to a clearance which is formed outside the film removing space and between the film removing unit and the substrate. By doing so, the clearance between the film removing unit and the substrate outside the film removing space is filled with the liquid, and the movement of the liquid which tends to flow out to the clearance from the film removing space can be suppressed. Therefore, the liquid in the film removing space can be appropriately drained, and the liquid containing the decomposed film can be prevented from spreading on the substrate.

Moreover, even if the suction opening of the film removing unit is arranged above the predetermined region, the laser beams emitted from the above cannot be blocked. Therefore, since suction can be effected with the suction opening being in contiguity with the predetermined region, the component of the film decomposed by the laser beams can be efficiently and precisely discharged. Additionally, it is known from an experiment conducted by the present inventors and others that particles of the film decomposed by the laser beams float in the upper direction, and enabling the suction opening to be arranged above the predetermined region is effective in light of this fact.

Further, the film removing unit may comprise a fluid supply portion which supplies a fluid to the vicinity of the predetermined region of the substrate. When suction from the suction opening is continued, a peripheral portion of the suction opening generally tends to have a negative pressure, and suction then becomes difficult. Since a fluid such as a gas can be supplied to the vicinity of the predetermined region by using the fluid supply portion, a pressure of the peripheral portion having the negative pressure can be restored, and suction power from the suction opening can be maintained. Therefore, discharge of the decomposed film from the suction opening can be preferably carried out, and particles of the film can be prevented from again adhering to the substrate. It is to be noted that a plurality of fluid supply portions may be provided on the same circumference with the predetermined region at the center.

Moreover, it is preferable that a first nozzle and a second nozzle are provided and a liquid from the first nozzle can be emitted at a speed greater than that of a liquid from the second nozzle. A flow (first flow) of the liquid which passes through the predetermined region is formed by the first nozzle arranged in contiguity with the predetermined region. Additionally, a flow (second flow) of the liquid whose speed is less than that of the first flow is formed by the second nozzle. In this state, the predetermined region can be irradiated with the laser beams, and the film removing operation can be performed. In this case, a difference in pressure is produced between the first flow and the second flow, and a force which is directed from the second flow side to the first flow side is generated. As a result, the liquid having the first flow, i.e., the liquid containing the component of the abraded film can be suppressed from spreading on the substrate. Therefore, the component of the film can be restrained from again adhering to the substrate.

To a mask member is provided a through hole used to bring a part of the flow of the liquid into contact with the predetermined region. The liquid emitted from the nozzle flows on the mask member, and comes into contact with the predetermined region on the substrate at the position of the through hole on the way. As a result, the component of the film abraded from the predetermined region can be taken into the flow of the liquid on the mask member, and removed from the substrate. Consequently, the liquid containing the component of the abraded film can be suppressed from coming into contact with parts other than the predetermined region, and hence the component of the film can be restrained from again adhering to the substrate. Further, contact between the liquid and the substrate surface can be suppressed, thereby simplifying post-processing such as cleansing the substrate.

Furthermore, the mask member may be formed into a tabular shape, a lower surface of the mask member may be formed horizontally, and an upper surface of the same may be inclined in such a manner that a height of the through hole becomes minimum. Moreover, the mask member may be formed into a circular shape as seen from a plane, and the through hole may be provided at the central part of the circular shape.

The film removing apparatus can be arranged at a position opposed to the through hole of the mask member and comprises a guide member which suppresses the flow of the liquid on the mask member on the upper side. The guide member may be formed of a transparent member which can move up/down without restraint and transmits the laser beams from the laser source to the predetermined region. In this case, the flow velocity of the liquid can be adjusted by moving up/down the guide member and adjusting a width of a flow path of the liquid. As a result, the component of the film abraded from the predetermined region is taken into the liquid having a fixed flow velocity, and preferably removed from the substrate.

A film removing method according to the present invention comprises:

(a) substantially horizontally holding a substrate so as to set a coating film on an upper side, emitting a predetermined fluid from a main nozzle onto the substrate, supplying the predetermined fluid to a predetermined region on the substrate by using a guide member, sucking the predetermined fluid existing at the predetermined region or the predetermined fluid which has passed through the predetermined region by using a suction opening and recovering it from the substrate;

(b) locally irradiating the predetermined region with laser beams with the predetermined fluid being caused to flow, partially abrading the coating film from the substrate, sucking an abraded film component together with the predetermined fluid on the substrate by using the suction opening, and removing it.

According to the present invention, the film abraded from the substrate by the laser beams are taken into the liquid, and recovered together with the liquid. Therefore, the abraded film can be prevented from floating along the circumference and again adhering to the substrate.

A substrate processing system according to the present invention comprises: a substrate carry-in-and-out portion; a processing portion including a film forming apparatus and a film removing apparatus; a carriage mechanism which carries a substrate between the film forming apparatus and the film removing apparatus,

wherein the film removing apparatus comprises: a substrate holding portion which holds a substrate having a coating film; a laser source which locally irradiates a predetermined region of the substrate on this substrate holding portion with laser beams and partially abrades the coating film from the substrate; a fluid supply mechanism including a main nozzle which supplies a predetermined fluid to the predetermined region; a recover mechanism having a suction opening which sucks and removes the predetermined fluid supplied to the predetermined region together with an abraded film component on the substrate; and a guide member which guides the predetermined fluid emitted from the main nozzle to the predetermined region, and guides the predetermined fluid and the abraded film component to the suction opening of the recovery mechanism so as to prevent them from being diffused/leaked around the predetermined region.

A substrate processing system according to the present invention comprises: a substrate carry-in-and-out portion; a processing portion including a film forming apparatus and a film removing portion; and a carriage mechanism which carries a substrate between the film forming apparatus and the film removing portion,

wherein the film removing apparatus comprises: a substrate holding portion which holds a substrate having a coating film; a laser source which locally irradiates a predetermined region of the substrate on this substrate holding portion with laser beams and partially abrades the coating film from the substrate; and a main nozzle which supplies a predetermined fluid to the predetermined region, the film removing apparatus further comprising: a film removing unit which includes a first suction opening which sucks and removes the predetermined fluid supplied to the predetermined region together with an abraded film component on the substrate, guides the predetermined fluid emitted from the main nozzle to the predetermined region, and guides the predetermined fluid and the abraded film component to the first suction opening so as to prevent them from being diffused/leaked around the predetermined region; a fluid supply mechanism which supplies the predetermined fluid to the main nozzle; and a recovery mechanism which communicates with the first suction opening.

According to the present invention, the laser beams are emitted, and the film abraded from the substrate is immediately discharged. Therefore, the abraded film can be prevented from floating in the circumference and again adhering to the substrate, and the operation to remove the film from the substrate can be performed without contaminating the substrate. Further, since a liquid is not used, post-processing such as drying processing is not required.

The substrate having a film formed by the film forming apparatus can be rapidly and assuredly carried to the film removing apparatus. Therefore, it is possible to prevent an operator from damaging the substrate during carriage, which was observed in the prior art. Furthermore, since carrying time is reduced, contamination of the substrate during carriage can be decreased. A reduction in the carrying time decreases the processing time of the entire processing of the substrate, thereby improving a throughput.

The substrate can be rapidly and securely carried between the film removing portion, the first film forming apparatus and the second film forming apparatus by the carriage mechanism. Since two film forming apparatuses are provided, different types of film can be formed in one system. As a result, since the substrate does not have to be carried to another system in the case of forming different types of films on the substrate, contamination of the substrate due to carriage can be reduced. Moreover, the processing time can be decreased.

A heat treatment device which heat-treats the substrate is provided to the processing portion, and the carriage mechanism may be able to carry the substrate with respect to the heat treatment device without restraint. In such a case, heating and cooling processing or the like after forming a film can be performed in the same system. It is to be noted that the heat treatment device includes a heating processing device, a cooling processing device or the like.

Additionally, the substrate processing system may have an interface portion which comprises a carriage device which carries the substrate between the processing portion and an exposure device provided outside the system. As a result, the substrate in the system can be rapidly carried to the exposure device. Therefore, the substrate processing including the exposure processing can be continuously carried out, thereby reducing the processing time of the substrate.

Further, it is preferable for the film removing portion to have an outlet from which an air is injected out to a rear surface of an outer edge portion of the substrate held by the substrate holding portion. Since the air can be injected to the rear surface of the outer edge portion of the substrate when a liquid flows on the substrate, the liquid dropping from the outer edge portion of the substrate can be prevented from flowing to the rear surface of the substrate. Therefore, contamination of the rear surface of the substrate which can be a factor of particles can be avoided. Furthermore, since the rear surface of the substrate does not have to be cleansed, the processing step of the substrate can thus be simplified.

The film removing apparatus may have a gas emission portion which emits a jet of a gas onto the substrate. In this case, since a gas can be discharged onto the substrate and the liquid remaining on the substrate can be blown away, the drying processing of the substrate can be emitted or simplified.

In such a case, even if a suction opening of the film removing unit is arranged above a predetermined region, the laser beams from the above are not blocked. Therefore, since the suction opening can be moved close to the predetermined region and suction can be performed, particles of the film decomposed by the laser beams can be efficiently and accurately discharged. Furthermore, it is known from an experiment conducted by the present inventors and others that the particles of the film decomposed by the laser beams float in the upper direction, and enabling arrangement of the suction opening above the predetermined region is effective in this regard.

Moreover, the substrate processing system may comprise a fluid supply portion which supplies a fluid to the vicinity of the predetermined region of the substrate. When suction from the suction opening is continued, a periphery thereof generally gradually has a negative pressure, and it becomes hard to effect suction in the end. According to the present invention, since the fluid such as a gas can be supplied to the vicinity of the predetermined region by using the fluid supply portion, a pressure of the periphery having a negative pressure can be restored, and a suction force from the suction opening can be maintained. Additionally, a smooth flow directed toward the suction opening from the fluid supply portion can be formed, and a component of the film abraded at the predetermined region can be caused to efficiently flow into the film removing unit. Therefore, removal of the decomposed film can be preferably performed, and particles of the film can be prevented from again adhering to the substrate. It is to be noted that the “fluid” includes a gas such as nitrogen, oxygen and the like or a liquid such as pure water.

The substrate processing system may comprise a movement mechanism which moves the substrate holding portion in a horizontal plane. As a result, the substrate carried into the film removing portion can be moved to a predetermined region irradiated with the laser beams.

Further, the processing system may comprise a position detection member used to detect a position of the substrate held by the substrate holding portion. In such a case, since a position of the substrate can be detected, the position of the substrate can be corrected based on the detected position. Therefore, the substrate can be moved to a further accurate position, and the laser beam can be more accurately emitted.

The substrate processing system may comprise a cup surrounding the substrate held by the substrate holding portion. Furthermore, the substrate processing system may comprise an air conditioning device which forms a descending flow of clean air in the film removing region. By forming a descending flow of clean air in the film removing portion during the film removing processing, particles generated from the substrate or the drive portion can be discharged, and the inside of the film removing region can be maintained in a clean atmosphere. Therefore, floats such as dust can be prevented from adhering to the substrate, and the substrate can be preferably processed.

### BRIEF DESCRIPTION OF THE SEVERAL VIEWS OF THE DRAWING

FIG. 1 is an internal perspective plane view of a substrate processing system;

FIG. 2 is a front view of the substrate processing system;

FIG. 3 is a rear view of the substrate processing system;

FIG. 4 is an internal perspective cross-sectional view of an antireflection film forming device (or a resist application device);

FIG. 5 is a block cross-sectional view showing an outline of a film removing apparatus according to the present invention;

FIG. 6 is a block cross-sectional view schematically showing the film removing apparatus according to the present invention;

FIG. 7 is a plane view showing a lower outlet arranged in a cup;

FIG. 8 is a perspective view of a guide member;

FIG. 9 is a type drawing showing the film removing apparatus when removing a resist film from an alignment mark;

FIG. 10 is a perspective view of a recovery nozzle having a suction opening;

FIG. 11 is a perspective view of a wafer having alignment marks covered with a coating film;

FIG. 12 is a cross-sectional type drawing showing an alignment mark part in an enlarged manner;

FIG. 13 is a cross-sectional type drawing showing how a resist film is removed from the alignment mark;

FIG. 14 is an enlarged type drawing showing a recovery nozzle according to another embodiment;

FIG. 15 is a type drawing showing a main nozzle which emits a jet of a fluid directly aiming at a film removing position and a guide member;

FIG. 16 is a type drawing showing the guide member having a vibrator;

FIG. 17 is a type drawing showing a substrate holding portion (chuck) having a vibrator;

FIG. 18 is a type drawing showing a film removing apparatus comprising a rectifying plate (mask member);

FIG. 19 is a plane view showing the main nozzle, a sub-nozzle and the guide member;

FIG. 20 is a plane view showing a pair of main nozzles arranged so as to be opposed to each other and the guide member;

FIG. 21 is a cross-sectional type drawing showing a film removing unit (block type);

FIG. 22 is a perspective view perspectively showing an inner flow path of the film removing unit (block type);

FIG. 23 is a cross-sectional type drawing of the film removing unit (block type) having a sub-nozzle;

FIG. 24 is a block cross-sectional view of the film removing unit (chamber type; for a gas) having a plurality of main nozzles;

FIG. 25 is a plane view of the film removing unit of FIG. 24 seen from below;

FIG. 26 is a block cross-sectional view of the film removing unit (chamber type; for a liquid) having a plurality of main nozzles;

FIG. 27 is a cross-sectional type drawing showing the film removing unit having an auxiliary nozzle besides the main nozzle;

FIG. 28 is a plane view of the film removing unit depicted in FIG. 27;

FIG. 29 is an enlarged type drawing showing flows of a liquid (pure water) discharged from each of the main nozzle and the auxiliary nozzle;

FIG. 30 is a cross-sectional view showing a primary part of a film removing apparatus comprising a mask member;

FIG. 31 is a vertical cross-sectional view of a film removing unit (chamber type; for a gas);

FIG. 32 is a cross-sectional view of the film removing unit depicted in FIG. 31 taken along the line A-A;

FIG. 33 is a vertical cross-sectional view of another film removing unit (chamber type; for a gas);

FIG. 34 is a plane view of the film removing unit depicted in FIG. 33;

FIG. 35 is a block cross-sectional view of still another film removing unit (chamber type; for a gas);

FIG. 36 is a cross-sectional view of the film removing unit depicted in FIG. 35 taken along the line B-B;

FIG. 37 is a plane view of yet another film removing unit;

FIG. 38 is a cross-sectional view of the film removing unit (chamber type; for a gas) depicted in FIG. 37 taken along the line C-C;

FIG. 39 is a cross-sectional view of the film removing unit (chamber type; for a gas) depicted in FIG. 37 taken along the line D-D;

FIG. 40 is a plane view of another film removing unit;

FIG. 41 is a cross-sectional view of the film removing unit (chamber type; for a gas) depicted in FIG. 40 taken along the line C-C;

FIG. 42 is an internal perspective cross-sectional view showing a substrate processing system comprising a film removing apparatus and an air knife unit according to the present invention;

FIG. 43 is an explanatory drawing of a vertical cross section showing an internal structure of a film removing apparatus comprising a film removing unit (chamber type; for a liquid); and

FIG. 44 is an internal perspective cross-sectional view showing a substrate processing system comprising a film removing apparatus and an interface portion according to the present invention.

### DETAILED DESCRIPTION OF THE INVENTION

Various preferred embodiments according to the present invention will now be described hereinafter with reference to the accompanying drawings.

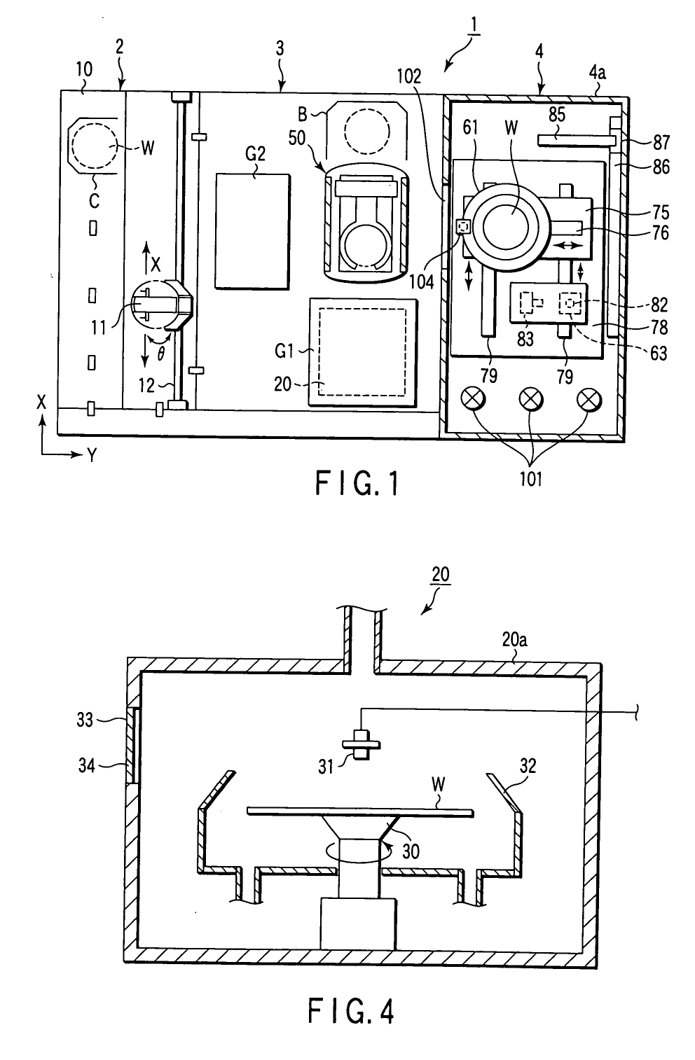

As shown in FIG. 1, a substrate processing system 1 has a structure in which a cassette station 2 as a carry-in-and-out portion which accepts, e.g., 25 wafers W in a cassette unit from the outside into the substrate processing system 1 and takes in and out the wafers W with respect to a cassette C, a processing station 3 as a processing portion which applies predetermined processing such as a heat treatment or film forming processing to the wafer W in a sheet-fed manner, and a film removing apparatus 4 as a film removing region which is provided so as to be adjacent to the processing station and removes a part of a film formed on the wafer W by the processing station 3 are integrally connected with each other.

In the cassette station 2, a plurality of cassettes C are mounted in a line along an axis X at predetermined regions on a cassette mount base 10 as a mounting portion. A carriage path 12 extends in a direction of an axis X, and a sub-arm carriage mechanism 11 is movably provided along the carriage path 12.

The sub-arm carriage mechanism 11 comprises a holder used to hold a wafer, a forward/backward movement drive mechanism which moves forward or backward the wafer holder in an X-Y plane, and a 0 drive mechanism which swivels the wafer holder around an axis Z. Further, the sub-arm carriage mechanism 11 includes an alignment function to position the wafer W. As will be described later, this sub-arm carriage mechanism 11 can also access an extension device 43 which belongs to a second processing device group G2 on the processing station 3 side.

In the processing station 3, various processing devices which apply predetermined processing are arranged in multiple stages and constitute a plurality of processing device groups. In this processing system 1, two processing device groups G1 and G2 are arranged. For example, the first processing device group G1 is arranged on the front side of the processing system 1, and the second processing device group G2 is arranged on the cassette station 2 side of the processing station 3. Furthermore, a buffer cassette B which can accommodate the plurality of wafers W in multiple stages is provided to the processing station 3. The buffer cassette B is arranged on, e.g., a rear surface side of the processing station 3. The buffer cassette B mounts and accommodates the wafer W in each stage by supporting an outer edge portion of the wafer W.

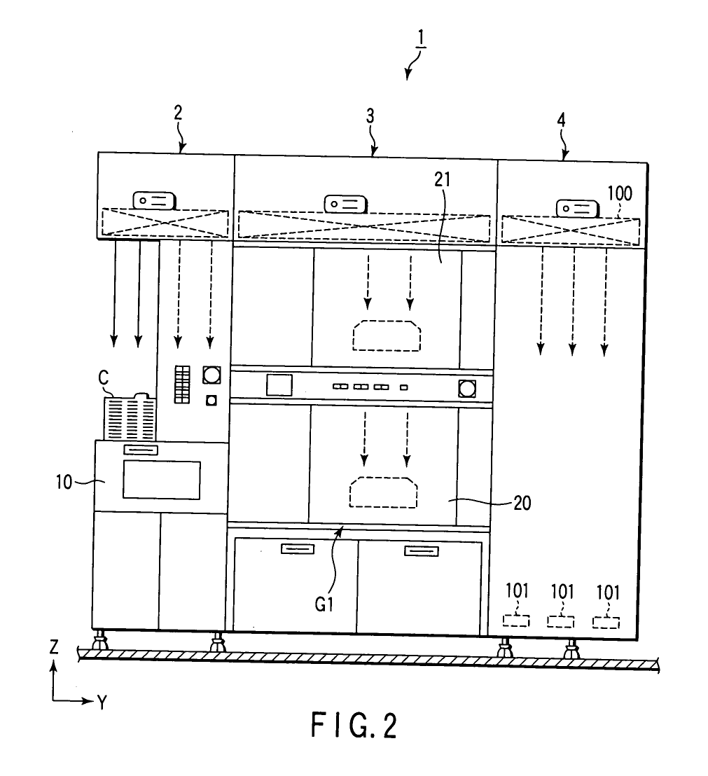

As shown in FIG. 2, in the first processing device group G1, an antireflection film forming device 20 as a film forming device and a first film forming device to form an antireflection film as a film on the wafer W and a resist applying device 21 as a second film forming device to form a resist film as a film on the wafer W are arranged on two stages in order from the lower side. The antireflection film is a film which prevents light beams from being reflected to the substrate at the time of exposure and alleviates deformations of a resist pattern caused due to a standing wave effect. It is to be noted that the number of the first processing device group G1 can be arbitrarily selected and multiple groups G1 may be provided.

As shown in FIG. 4, the antireflection film forming device 20 comprises a spin chuck 30, a nozzle 31 and a cup 32 in a casing 20a in order to apply and form the antireflection film on the entire upper surface of the wafer W by a spin coating method. The spin chuck 30 includes a function to suck and holds the wafer W and rotate it around the axis Z. The nozzle 31 communicates with a non-illustrated liquid supply source and supplies a processing liquid (solution for the antireflection film) to the wafer W on the spin chuck 30. The cup 32 includes a function to receive the processing liquid scattered from the wafer W and discharge the processing liquid to a recovery tank (not shown) through a drain tube.

A carriage opening 33 used to carry in and out the wafer W is provided on a side surface of the casing 20a. Furthermore, to this carriage opening 33 is attached a shutter 34 which opens and closes the carriage opening 33 with a predetermined timing.

It is to be noted that the resist applying device 21 has substantially the same structure as that of the antireflection film forming device 20, thereby eliminating its explanation.

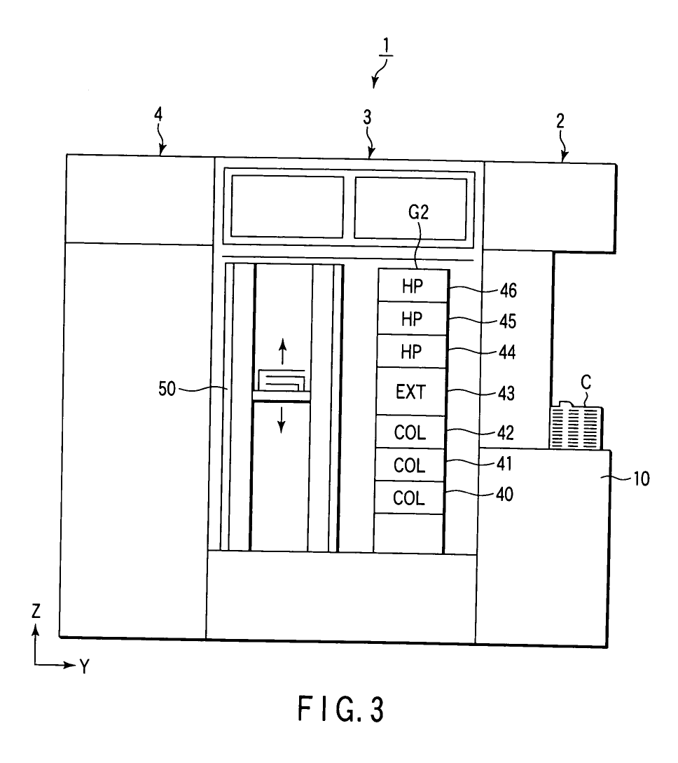

As shown in FIG. 3, in the second processing device group G2, cooling devices 40, 41 and 42 which apply cooling processing to the wafer W, an extension device 43 as a delivery portion which delivers the wafer W and heating processing devices 44, 45 and 46 which apply heating processing to the wafer W are superposed on seven stages from the lower side. It is to be noted that the heat treatment device in this embodiment corresponds to the cooling devices 40 to 42 and the heating processing devices 44 to 46. The wafer W is heated or cooled to a predetermined temperature on a plate of each of these heat treatment devices. It is to be noted that the heat treatment device may be a heating/cooling device which includes both a plate used to apply heating processing and a plate used to apply cooling processing.

To the processing station 3 are provided each processing device in the first processing device group G1, each processing device in the second processing device group G2, and a main arm carriage mechanism 50 as a carriage mechanism which carries the wafer W between the buffer cassette B and a later-described film removing apparatus 4. Since the main arm carriage mechanism 50 is disclosed in U.S. Pat. No. 5,664,254, thereby eliminating the detailed explanation.

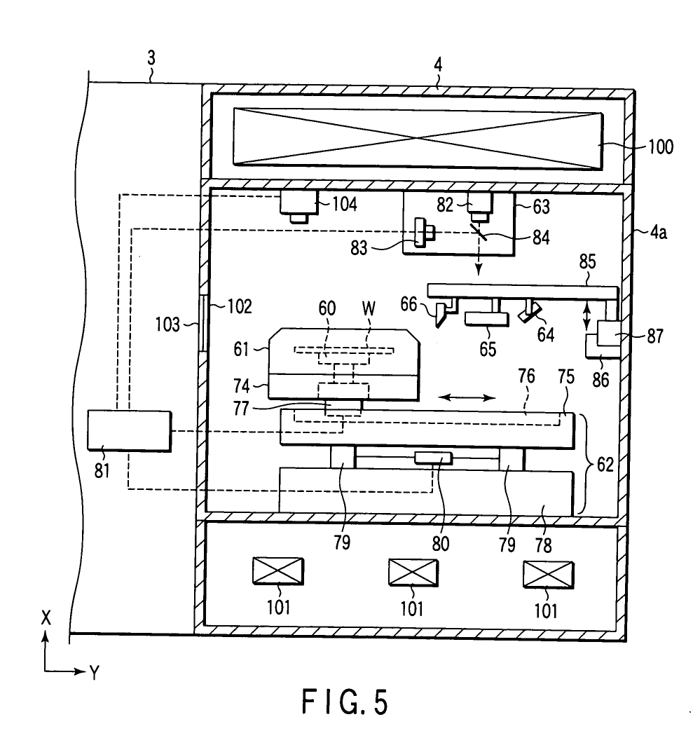

As shown in FIG. 5, the film removing apparatus 4 comprises in a casing 4a a chuck 60, a cup 61, an X-Y stage 62, a laser device 63, a main nozzle 64, a guide member 65, a recovery nozzle 66 and others. The chuck 60 has a non-illustrated suction opening formed on an upper surface thereof, and functions as a substrate holding portion which sucks and horizontally holds the wafer W with vacuum.

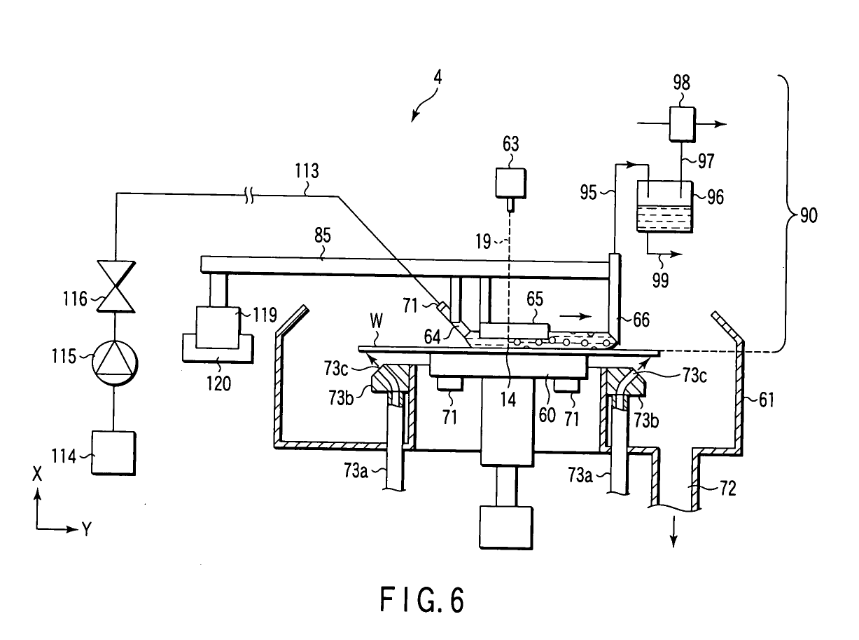

As shown in FIG. 6, the chuck 60 is supported by a drive portion 70 so as to be capable of rotating and moving up and down. That is, the drive portion 70 includes a motor which rotates the chuck 60 at a high speed, and a cylinder which moves up and down the chuck 60. An ultrasonic vibrator 71 is attached to the chuck 60, and it vibrates the chuck 60 itself and propagates ultrasonic vibrations to a liquid belched onto the wafer W from the main nozzle 64. As a result, components of a film fetched into the liquid flowing on the wafer W can be prevented from again adhering to the wafer W.

The cup 61 is provided so as to surround the chuck 60 in a substantially cylindrical shape with an upper surface thereof being opened. A discharge opening 72 from which a liquid or a gas in the cup 61 is discharged is provided to the lower portion of the cup 61, and the liquid dropped or scattered from the wafer W is received by the cup 61 and discharged from the discharge opening 72.

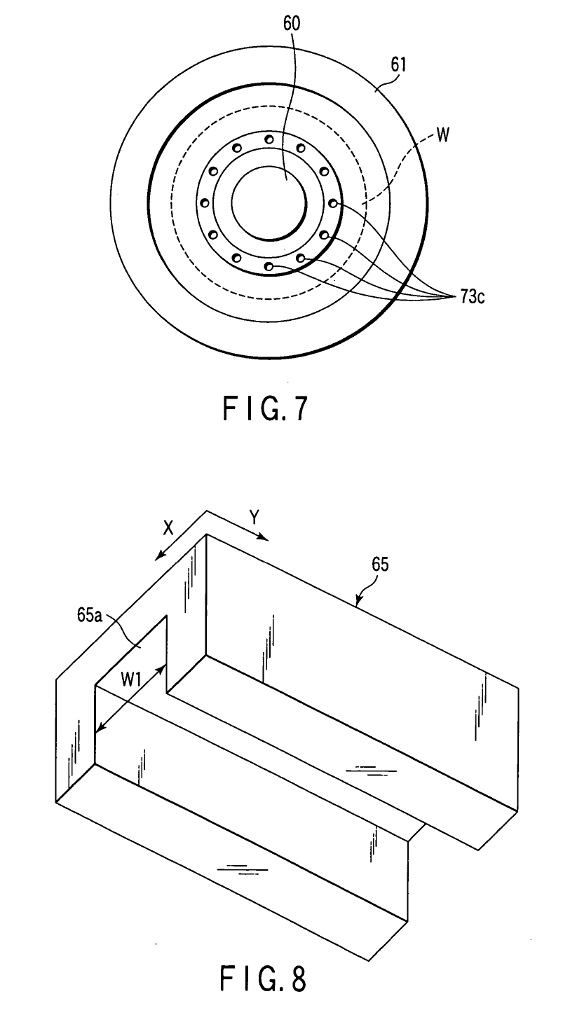

A plurality of outlets 73c from which a gas is blown out to a rear surface of the outer edge portion of the wafer W are provided below the wafer W in the cup 61. The outlets 73c are provided at equal intervals on the same circumference as shown in FIG. 7. A gas is supplied to the outlets 73c from, e.g., a non-illustrated gas supply device with a predetermined timing and a pressure. By belching out the gas to the rear surface of the outer edge portion of the wafer W in this manner, the liquid flowing on the upper surface of the wafer W can be prevented from moving to the rear surface side. It is to be noted that using an inert gas, a nitrogen gas, air or the like as the gas to be belched out is good. Moreover, as shown in FIG. 5, the entire cup 61 is supported by a substantially cylindrical support container 74 having a closed lower surface. The chuck 60 is accommodated in the support container 74.

The X-Y stage 62 functions as a movement mechanism which moves the spin chuck 60 and the cup 61 in the horizontal direction. The X-Y stage 62 comprises two plates arranged on, e.g., upper and lower sides. A rail 76 which extends in a direction of the axis Y is formed on the upper first plate 75 as shown in FIGS. 1 and 5. The support container 74 is provided on the rail 76, and can move on the rail 76 in the direction of the axis Y by a drive portion 77 such as a motor.

On the other hand, a rail 79 which extends in a direction of the axis X is provided on the lower second plate 78 as shown in FIGS. 1 and 5. The first plate 75 is provided on this rail 79, and can move on the rail 79 in the direction of the axis X by a drive portion 80 such as a motor. With this structure, the support container 74 on the first plate 75 can move both in the direction of the axis X and the direction of the axis Y. Therefore, the support container 74 can move to a predetermined region on the X-Y plane together with the cup 61 or the chuck 60.

Additionally, driving of the drive portion 77 and the drive portion 80 of the X-Y stage 62 is controlled by a control portion 81. That is, a destination of the cup 61 or the chuck 60 can be set and controlled by using the control portion 81. Therefore, the wafer W held by the chuck 60 can be moved to a laser beam irradiation position below the laser device 63, and a desired film removing position on the wafer W can be irradiated with laser beams.

The laser device 63 contains a laser oscillator, a power supply, a power supply controller and the like, and includes a function to irradiate a coating film which covers a predetermined region 14 (alignment mark 15) of the wafer W with laser beams and decompose and evaporate the coating film. As the laser oscillator 63, a processing laser such as a YAG laser or an excimer laser is used. The laser oscillator 63 is fixed and provided to, e.g., a casing (not shown) of the film removing apparatus 4, and an optical system which is accurately set can be thereby maintained. The laser oscillator 63 is designed to be capable of emitting laser beams toward the lower perpendicular direction. It is to be noted that the laser oscillator may be attached so that laser beams can be emitted in a predetermined deflection angle direction.

The laser device 63 according to this embodiment is fixed to the upper surface of the casing 4a. The laser device 63 comprises, e.g., a laser oscillator 82 as a beam source of laser beams and a CCD camera 183 as a position detection member used to detect a position of the wafer W. The laser oscillator 82 is attached so as to be capable of emitting laser beams toward the lower perpendicular direction. Therefore, an X-Y coordinate in the horizontal plane of the laser oscillator 82 matches with an X-Y coordinate of a laser beam irradiation position. It is to be noted that a processing laser such as a YAG laser or an excimer laser is used as the laser oscillator 82. Additionally, the laser beams may be emitted in a predetermined direction. It is to be noted that a laser beam diameter at a focal position is adjusted to, e.g., 250 μm×100 μm in the laser device 63 according to this embodiment.

The CCD camera 83 can reflect an image at, e.g., a laser irradiation position by using a half mirror provided on the same optical axis as that of the laser oscillator 82, and pick up an image. That is, the CCD camera 83 can pick up an image at the laser irradiation position seen from the laser oscillator 82. Imaging data of the wafer W picked up by the CCD camera 83 is outputted to, e.g., the control portion 81. The control portion 81 recognizes a current position of the wafer W based on the imaging data, and compares the current position with a predetermined optimum position. If the current position deviates from the optimum position, the control portion 81 can issue a command to the drive portions 77 and 80 of the X-Y stage 62, and correct the position of the wafer W to an appropriate position. That is, it can perform accurate position correction in such a manner that a film removing position on the wafer W becomes a laser irradiation position.

The main nozzle 64, the guide member 65 and the recovery nozzle 66 are attached to a holding arm 85 which can move in, e.g., a direction of the axis X. As shown in FIG. 1, the holding arm 85 extends in a direction of the axis Y, and is provided so as to be capable of traveling in a direction of the axis X along the rail 86. That is, the holding arm 85 is supported by a drive portion 87 which comprises a motor. Further, a cylinder or the like which moves up and down the holding arm 85 is provided to the drive portion 87, and a height of the guide member 65 or the like can be adjusted by upward or downward movement of the holding arm 85. That is, the holding arm 85 can accurately adjust a distance between the guide member 65 and the wafer W, the guide member 65 being moved close to the wafer W. Therefore, a thickness Tl of a fluid 17 (pure water) flowing through a lead groove 65a for the guide member 65 can be adjusted.

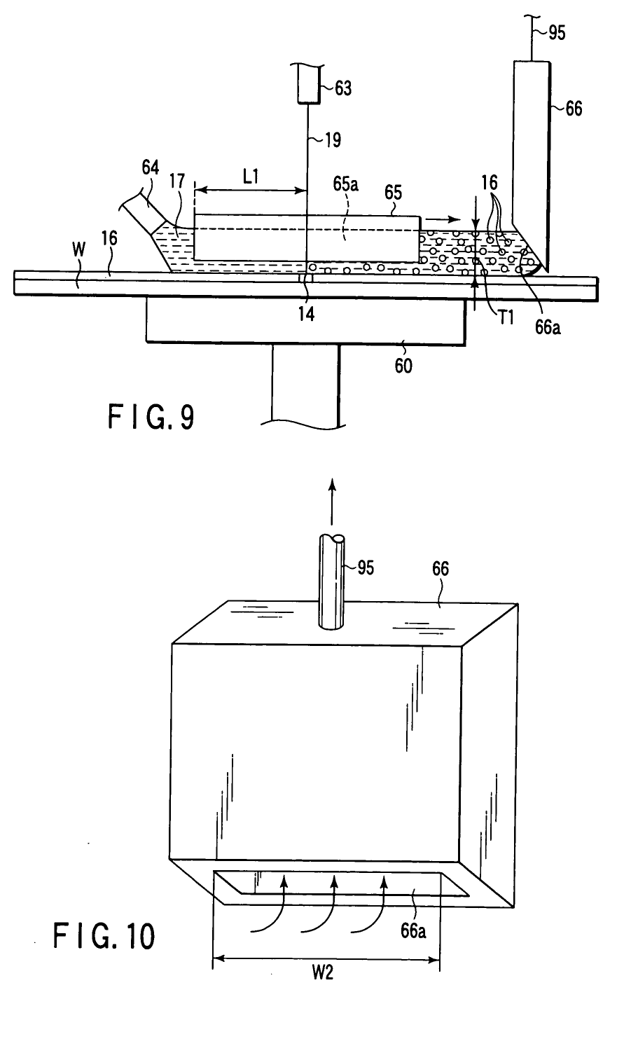

Furthermore, the holding arm 85 can move the main nozzle 64 or the guide member 65 to a laser irradiation position from, e.g., a predetermined standby portion. The holding arm 85 holds the guide member 65 at a position optimum with respect to the wafer W and the main nozzle 64. For example, as shown in FIG. 9, the guide member 65 is arranged in such a manner that a distance L1 (run-up distance of pure water) from the laser irradiation region 14 to an end portion of the guide member 65 on the main nozzle 64 side becomes not less than 6 mm. As a result, the run-up distance L1 of pure water belched out from the main nozzle 64 can be sufficiently assured, and a flow of pure water can be caused to enter a stable laminar flow state before this flow reaches the laser irradiation position.

As shown in FIG. 6, the main nozzle 64 communicates with a fluid supply mechanism through a pipe arrangement 113, and includes a function to supply pure water as a predetermined fluid onto the water W. The fluid supply mechanism has a supply source 116 in which pure water with a predetermined purity is stored, and comprises a pump 115 and a control valve 116 between the supply source 116 and the main nozzle 64. Operations of the pump 115 and the control valve 116 are controlled by a controller 81 shown in FIG. 5. When the controller 81 controls the operations of the pump 115 and the control valve 116 of the fluid supply mechanism, pure water is supplied to the main nozzle 64 with a predetermined timing and a predetermined pressure, and the pure water is belched out onto the wafer W from the main nozzle 64.

As shown in FIG. 8, the guide member 65 has a substantially rectangular parallelepiped shape, and a lead groove 65a which leads pure water from the main nozzle 64 is formed to a lower portion of the guide member 65. The lead groove 65a is linearly formed along the longitudinal (direction of the axis Y) of the guide member 65, and its width W1 (e.g., approximately 2 to 10 mm) is larger than a width of an alignment mark 15 at the film removing region 14.

The guide member 65 is attached to a position where the pure water belched out from the main nozzle 64 flows into the lead grove 65a. When this guide member 65 is moved close to the surface of the wafer W and the lead groove 65a is positioned above the film removing region 14, a liquid on the wafer W can be guided to the film removing region 14. A transparent member such as quartz glass is used for the guide member 65, and laser beams from the laser oscillator 63 can be transmitted therethrough without being attenuated nor reflected.

The guide member 65 is held by the holding arm 65 at a position of the Y coordinate which is equal to the laser irradiation position of the laser oscillator 82. That is, the guide member 65 can be moved to the laser irradiation position (directly above the film removing region 14) by moving the holding arm 85 in the direction of the axis X. A transparent member such as quartz glass is used for the guide member 65, and laser beams emitted from the upper laser oscillator 82 can be transmitted therethrough without being attenuated nor reflected.

A recovery nozzle 66 includes a function to recover a liquid flowing on the wafer W. As shown in FIG. 6, it is connected and caused to communicate with a recovery tank 96 by using a recovery tube 95. Furthermore, this recovery tank 96 is connected and caused to communicate with a suction mechanism, e.g., an ejector 98 by using a suction tube 97.

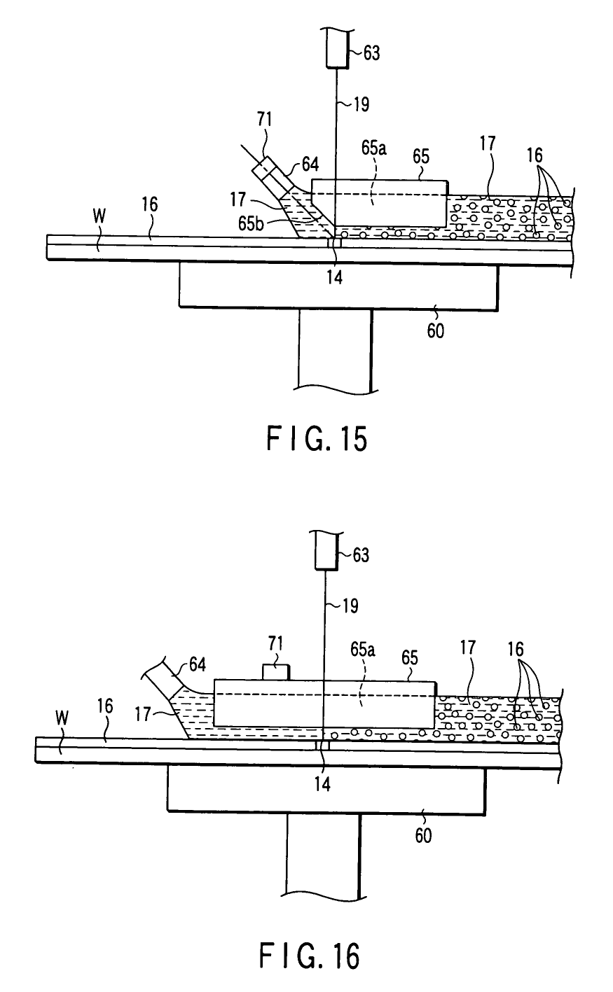

As shown in FIG. 15, a vibrator 71 is attached to the main nozzle 64, and vibrations with a predetermined frequency can be thereby transmitted to pure water belched out from the main nozzle 64. As a result, a abrading effect of the coating film of the wafer W irradiated with laser beams can be improved.

A recovery mechanism 90 comprises a recovery nozzle 66 which recovers pure water which has passed through, e.g., the guide member 65, a recovery tube 26 connected with the recovery nozzle 66, a recovery tank 27 in which pure water which has flowed through the recovery tube 26 is stored, and a suction mechanism which gives a suction force to the recovery nozzle 66, e.g., an ejector 28 and others.

As shown in FIG. 10, the recovery nozzle 66 has a substantially rectangular parallelepiped shape, and has an obliquely cut lower end portion. A slit-like suction opening 66a which communicates with a recovery tube 95 is formed to this nozzle lower end portion. The suction opening 66a is formed facing toward the guide member 65 as shown in FIG. 9, thereby facilitating recovery of a fluid (pure water+resist) which has passed through the guide member 65. A width W2 of the suction opening 66a is larger than a width W1 of the lead groove 65a of the guide member. It is preferable to set the width W2 to be 1.1-fold to 2.0-fold of the width W1, for example. The fluid (pure water+resist) can be sucked by such a wide suction opening 66a without leakage.

The recovery nozzle 66 is arranged on the downstream side of the guide member 65 while being held by the arm 85. The recovery nozzle 66 is positioned in such a manner that the suction opening 66a at the lower end portion thereof moves close to the wafer W when the guide member 65 is arranged in contiguity with the wafer W.

As shown in FIG. 6, the recovery tank 95 communicates with an upper portion of the recovery tank 96. A drain tube 99 is provided to a lower portion of the recovery tank 96. The recovered pure water 17 is temporarily stored in the recovery tank 96, and occasionally discharged from the recovery tank 96 through the drain tube 99.

A suction tube 97 which communicates with an ejector 98 is opened to the upper portion of the recovery tank 96. The inside of the suction tube 97 is caused to have a negative pressure by the ejector 98, a gas in the recovery tank 96 is sucked, and a suction force is given to the recovery nozzle 66. Furthermore, air (air bubbles) involved with the pure water 17 can be removed from the recovery tank 96 by suction through this suction tube 97. As a result, recovered matters can be gas-liquid-separated into a gas component and a liquid component in the recovery tank 96, and they are separately discharged. It is to be noted that the pure water discharged from the drain tube 99 may be subjected to purifying processing and then returned to the main nozzle 64 for recycle. Moreover, a vacuum pump may be used in place of the ejector as the suction mechanism.

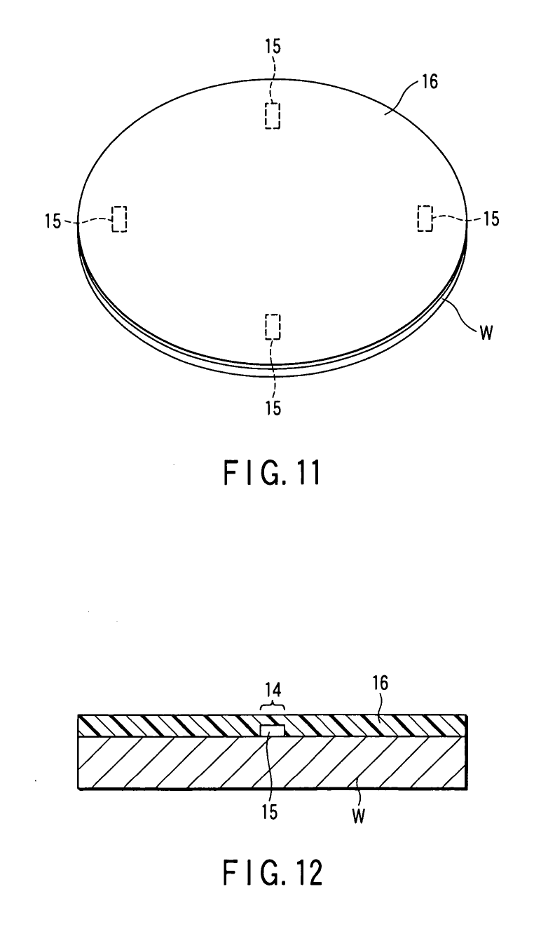

An effect of the film removing apparatus having the above-mentioned structure will now be described in detail. First, the wafer W having a plurality of alignment marks 15 such as shown in FIGS. 11 and 12 and having a resist 16 formed thereon is sucked and held on the chuck 60. At this moment, the wafer W may be delivered to the chuck 60 which has been moved up in advance from a predetermined carriage device (not shown) and in the standby mode. It is to be noted that the film removing region 14 is a position of each alignment mark 15 on the wafer W.

Subsequently, the cup 7 is moved from a position at which the wafer W was carried in, and the film removing region 14 of the wafer W is moved to the laser irradiation region. At this time, a movement position of the cup 7 may be controlled based on a detection result of position detecting means such as a CCD camera which detects a position of the wafer W.

Then, the main nozzle 64 and the guide member 65 are moved above the film removing region 14 of the wafer W from the standby portion by the holding arm 85, and arranged in contiguity with the upper part of the wafer W. A height of the guide member 65 at this moment is adjusted, and a thickness b of a liquid film 17 of pure water flowing through the lead groove 65a is adjusted so as to be not more than approximately 2 mm.

As shown in FIG. 9, the pure water starts to be emitted from the main nozzle 64 at, e.g., approximately 5 to 2 L/min, and a flow of the pure water passing on the film removing region 14 is formed in the lead groove 65a. At this time, the vibrator 71 vibrates with ultrasonic waves of approximately 0.4 to 1 MHz, and vibrations are propagated to the emitted pure water. Moreover, the ejector 28 is operated, and the pure water which has passed through the guide member 65 is recovered from the recovery nozzle 66 and drained. It is to be noted that the pure water which has not been recovered by the recovery nozzle 66 is recovered by the cup 7, and then drained from the discharge portion 11.

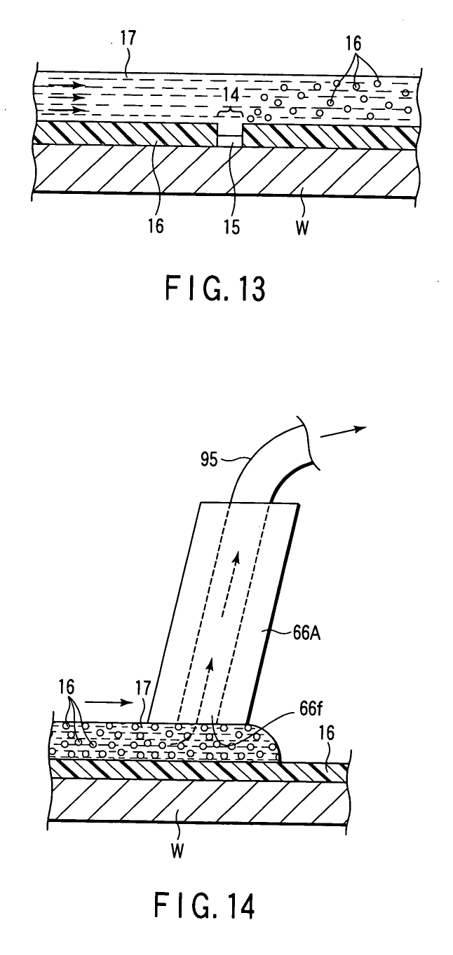

In a state that the pure water is caused to flow on the wafer W, laser beams are emitted from the laser oscillator 63 and transmitted through the guide member 65, and the film removing region 14 is irradiated with the laser beams. As a result, the resist 16 at the film removing region 14 is thereby decomposed and abraded from the wafer W as shown in FIG. 13. The resist 16 abraded by the laser beams or foreign particles generated from a thermal reaction by the laser beams are fetched into a flow of the pure water, and removed from the wafer W by the recovery nozzle 66.

When the laser beams are emitted for a predetermined time and the resist 16 at the film removing region 14 is removed, emission of the laser beams is stopped, and a jet of the pure water is also stopped. Additionally, after elapse of a predetermined time, the operation of the ejector 98 is stopped, and suction from the recovery nozzle 66 is terminated. Thereafter, the resist 16 on the other alignment marks 15 is likewise removed.

When the resist 16 at all the film removing regions 14 is removed, the main nozzle 64 and the guide member 65 move to the standby portion. Then, for example, the chuck 60 is rotated at a high speed, water droplets remaining on the wafer W are shaken off, and the wafer W is dried. When this shake-off drying is terminated, the cup 7 moves to a predetermined carry-out position, and a series of the removing processing of the resist 16 is completed.

According to the above-described embodiment, since the resist 16 on the alignment mark 15 as the film removing region 14 is decomposed while causing the pure water to flow on the wafer W and the pure water which has taken in the decomposed matters is rapidly recovered, the resist 16 as the decomposed matter can be prevented from again adhering to the wafer W. Therefore, the film removing processing can be appropriately performed without contaminating the surface of the wafer W.

Since the guide member 65 is arranged on the wafer W and the pure water is led to the film removing region 14, a sufficient quantity of the pure water can be supplied to the film removing region 14, and the film can be assuredly removed. Further, since the pure water can be efficiently concentrated on the film removing region 14, a supply quantity of the pure water can be reduced. Since the emitted pure water is led onto the wafer W, the entire surface of the wafer W can be prevented from being wet with the pure water. Since the run-up distance L1 of the pure water belched out from the main nozzle 64 is sufficiently assured, a flow of the pure water is formed as a laminar flow when passing through the film removing region 14. Therefore, since air bubbles are not generated in the pure water by a turbulent flow and the laser beams are not diffused by the air bubbles, the resist 16 can be appropriately decomposed.

Since the vibrator 71 is attached to the main nozzle 64 and the ultrasonic vibrations are given to the pure water, it is possible to improve the abrading and removing effects of the pure water itself with respect to the resist 16 or the decomposed matters generated by emission of the laser beams. It is to be noted that only the pure water may be simply emitted without giving the ultrasonic vibrations to the pure water. Further, the emitted liquid is not restricted to the pure water, it may be pure water in which a gas such as carbon dioxide, oxygen, nitrogen or the like is mixed, or any other liquid such as ion water, ozone water or oxygenated water. Incidentally, it is preferable that the emitted liquid is adjusted to pH 4 to 6.

Furthermore, since a nitrogen gas is sprayed to a rim portion of the rear surface of the wafer W from the outlets 73c when supplying the liquid, the pure water can be prevented from flowing to the rear surface from the upper surface of the wafer W, thereby effectively avoiding contaminations of the rear surface of the wafer W. As a result, post-processes to cleanse the rear surface of the wafer W are not required, thus shortening an entire processing time of the wafer W.

Although an end portion of the recovery nozzle 66 described in connection with the above embodiment is inclined, the end portion 66f of the recovery nozzle 66A may be formed so as to be parallel with the wafer W. In such a case, the pure water which has entered a gap between the recovery nozzle 66A and the wafer W can be more assuredly recovered.

Moreover, as shown in FIG. 15, since an emission opening of the main nozzle 64 may be provided facing the film removing region 14 at which the resist 16 is removed. In such a case, the pure water having vibrations applied thereto in the main nozzle 64 directly collides with the resist 16 on the alignment mark 15, thereby further improving the abrading and removing effects of the pure water relative to the resist 16. It is to be noted that an inclined portion 65b which does not obstruct a flow of the pure water emitted from the main nozzle 64 may be provided to the guide member 65 in this example.

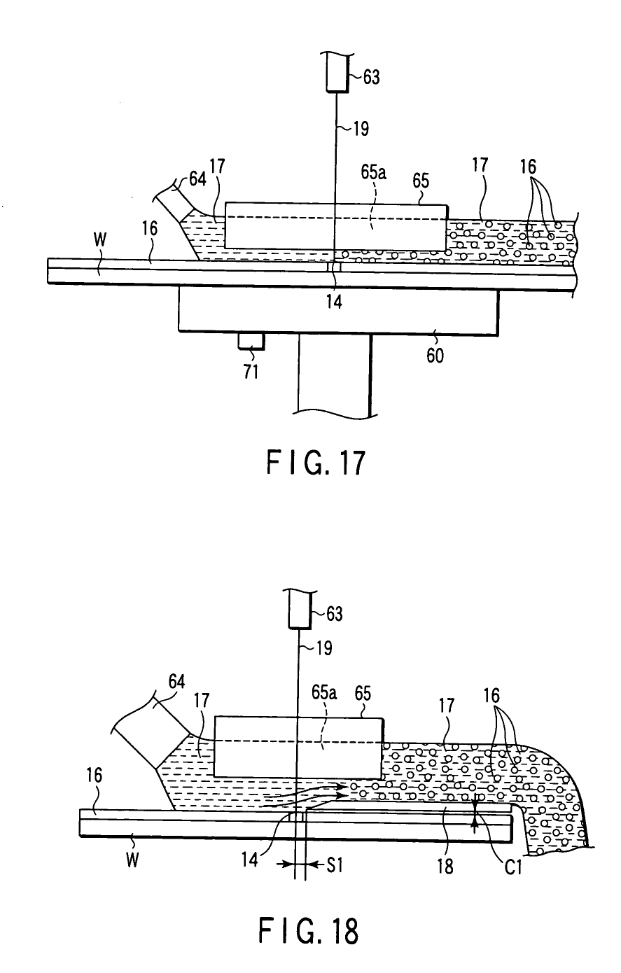

As shown in FIG. 16, the vibrator 71 may be attached on the guide member 65 side. Additionally, as shown in FIG. 17, it may be attached to the chuck 60. In these cases, vibrations can be transmitted to the pure water flowing on the wafer W, and the abrading and removing effects of the pure water relative to the resist 16 can be improved.

As shown in FIG. 18, a rectifying plate 18 may be provided in place of the recovery nozzle 66. The rectifying plate 18 is arranged on the downstream side away from the film removing region 14. The rectifying plate 18 is formed into a thin tabular shape with a thickness of, e.g., approximately 100 to 200 μm, and it is inserted between the wafer W and the guide member 65 from the downstream side of the guide member 65. The rectifying plate 18 is arranged in such a manner that a distance S1 between the end portion of the rectifying plate 18 on the upstream side and the film removing region 14 becomes, e.g., approximately 10 to 100 μm, and an end portion of the rectifying plate 18 on the downstream side is formed so as to reach the end portion of the wafer W. The end portion of the rectifying plate 18 on the upstream side is formed into a tapered shape that a lower side thereof protrudes. The rectifying plate 18 is arranged in contiguity with the wafer W in such a manner that it does not come into contact with the wafer W, e.g., that a distance C1 between itself and the wafer W becomes approximately 10 to 50 μm. The rectifying plate 18 is supported by, e.g., the holding arm 85 attached to the guide member 65, and integrally moved with the guide member 65.

In this embodiment, the pure water is emitted from the main nozzle 64, passed through the film removing region 14, and then led above the wafer by the rectifying plate 18. Therefore, the resist 16 abraded from the wafer W is prevented from again adhering to the wafer W, thereby avoiding contaminations of the wafer W. Furthermore, the recover nozzle 66 may be provided above the rectifying plate 18 in order to recover resist mixed water 16 and 17 by using the recovery nozzle 66. It is to be noted that a rear end portion of the rectifying plate 18 does not have to extend to a rim end portion of the wafer W, and it is good enough for this rear end portion to extend to the position of the recovery nozzle 66.

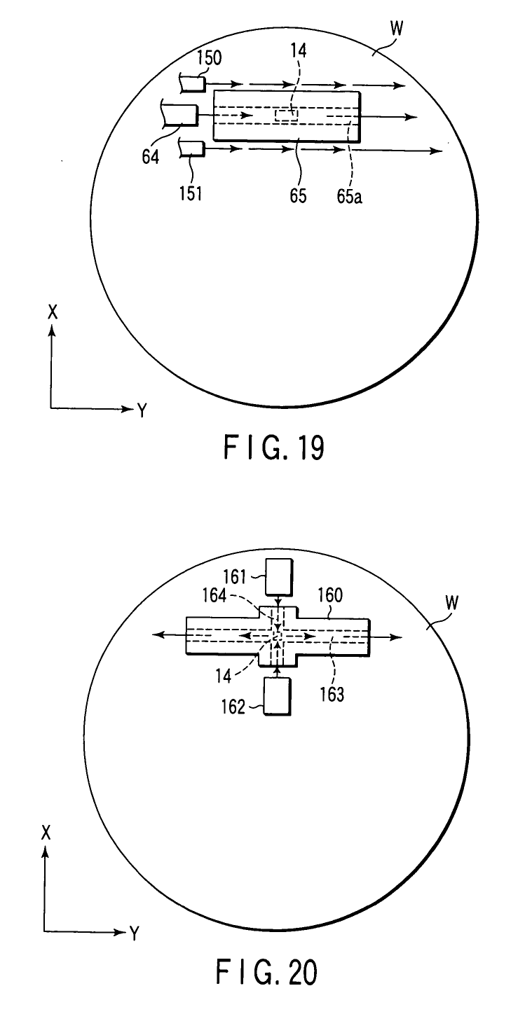

As shown in FIG. 19, in addition to the main nozzle 64, two sub-nozzles 150 and 151 may be also provided on both sides of the main nozzle 64. The pure water is emitted from the respective sub-nozzles 150 and 151 in the direction of the axis Y like the main nozzle 64. The sub-nozzles 150 and 151 are supported by the holding arm 85 together with the main nozzle 64. A distance between the sub-nozzles 150 and 151 is adjusted to be close to, e.g., a lateral width of the guide member 65.

When the pure water is supplied from the main nozzle 64, the pure water is also supplied from the sub-nozzles 150 and 151 in synchronization with this supply. As a result, there is formed such a flow that the water supplied from the sub-nozzles 150 and 151 sandwiches the water fed from the main nozzle 64 from the both sides, and the resist mixed water 16 and 17 can be suppressed from being diffused on the wafer W. Moreover, the water which has taken in the resist 16 and been contaminated can be linearly efficiently discharged to the outside of the wafer W. It is to be noted that the fluid supplied from the sub-nozzles 150 and 151 is not restricted to the pure water, and it may be any other liquid such as ion water. Additionally, it is not restricted to a liquid, and it may be a gas such as an inert gas, a nitrogen gas or an oxygen gas.

As shown in FIG. 20, a pair of side nozzles 161 and 162 may be attached to a guide member 160 in place of the main nozzle 64. The side nozzles 161 and 162 are attached to side portions of the guide member 160 in such a manner that they are oppositely arranged with equal distances from the film removing region 14, and emit a fluid in a direction of the axis X orthogonal to the longitudinal of the guide member 160. To the guide member 160 are formed a lead-in groove 164 which extends in the direction of the axis X and a lead groove 163 which extends in the direction of the axis Y, and the both grooves 163 and 164 cross each other at the film removing region 14.

When the fluids 17 (pure water) are simultaneously emitted from the both nozzles 161 and 162, the fluids 17 collide with each other at the film removing region 14 and are drained to the right and left sides together with the abraded resist 16 along the lead groove 163. Further, recovery mechanisms (not shown) may be provided to the both outlets of the lead groove 163 in order to recover the resist mixed water 16 and 17.

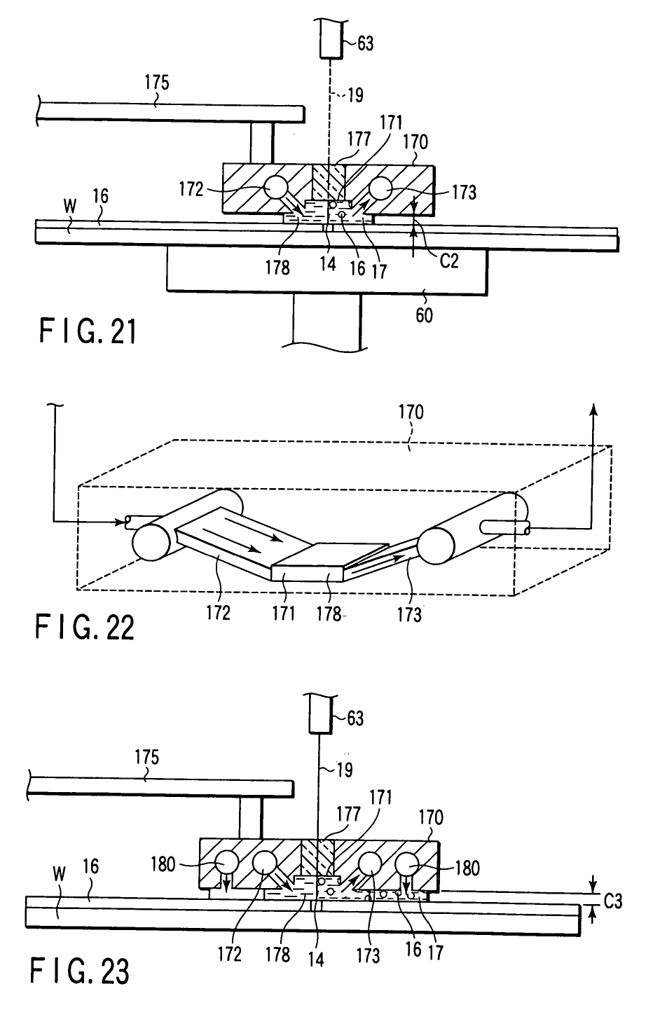

As shown in FIGS. 21 and 22, a film removing unit 170 may be provided between the laser oscillator 63 and the film removing region 14. The film removing unit 170 has a substantially rectangular parallelepiped shape, and has a concave portion 171 at the central portion of the lower surface thereof. The concave portion 171 faces the upper surface of the wafer W, and a film removing space 178 is formed between them. The film removing unit 170 comprises a supply tube 172 which supplies a liquid (pure water) to the film removing space 178, and a drain tube 173 from which the liquid in the space 178 is drained. The supply tube 172 and the drain tube 173 have widths equal to that of the concave portion 171, and an opening portion led to the concave portion 171 is formed in a slit-like shape.

The supply tube 172 communicates with a liquid supply tube 113 communicating with the supply source 114 shown in FIG. 6. The controller 81 supplies a signal to a power supply of the supply source 114, and causes the supply source 114 to supply a predetermined quantity of pure water into the space 178 through the supply tube 172 with a predetermined timing.

On the other hand, the drain tube 173 communicates with the recovery mechanism 90 comprising the ejector 98 shown in FIG. 6. The controller 81 supplies a signal to a power supply of the ejector 98, and causes the recovery mechanism 90 to suck the inside of the space 178 through the drain tube 173 with a predetermined pressure and timing, thereby draining the liquid from the space 178.

As shown in FIG. 21, a transparent member 177 formed of, e.g., glass is fitted in an upper center of the film removing unit 170. The laser beams 19 are transmitted through the transparent member 177, reach the inside of the film removing space 178 and enter the resist 16 at the region 14.

The film removing unit 170 is held by, e.g., a holding arm 75 having the same function as that of the above-described holding arm 85. As a result, the holding arm 75 can arrange the concave portion 171 of the film removing unit 170 so as to be opposed to the film removing region 14 on the wafer W, and move the film removing unit 170 closer to the surface of the wafer W. That is, the film removing space 178 which is a substantially sealed space formed by the concave portion 171 and the surface of the wafer W can be formed above the film removing region 14 on the wafer W. Incidentally, it is good enough to set a gap C3 between the wafer W and the lower surface of the film removing unit 170 to approximately 100 to 300 μm in such a manner that the pure water in the film removing space 178 does not leak.

Furthermore, when removing the resist 16 at the film removing region 14, the pure water is supplied from the supply tube 172 into the film removing space 178 formed above the film removing region 14. Moreover, the pure water in the film removing space 178 is drained when it is sucked from the drain tube 173. As a result, there is formed a flow of the pure water which flows through the supply tube 172, the coating film removing space 178 and the drain tube 178 in the mentioned order as shown in FIG. 22. Additionally, at this time, a supply quantity of the pure water to be supplied into the film removing space 178 and a drain quantity of the pure water to be drained are controlled so as to be equal to each other so that the pure water does not overflow from the film removing space 178. Thereafter, like the above-described embodiment, the film removing region 14 is irradiated with laser beams from the laser oscillator 63, and the resist 16 is abraded off. Then, the abraded resist 16 is taken into the pure water, and discharged from the drain tube 173 together with the pure water.

According to this example, since the liquid such as pure water is locally supplied into the film removing space 178, a consumption quantity of the liquid to be used can be reduced. Further, since the pure water which has taken in the resist and been contaminated does not spread over the surface of the wafer W, contaminations of the wafer W can be avoided.

As shown in FIG. 23, a sub supply tube 180 which supplies the pure water 17 may be provided to the gap C3 between the film removing unit 170 and the wafer W. Two, three or four sub-supply tubes 180 can be provided around the concave portion 171, for example.

When the pure water 17 is supplied from the supply tube 172 to the film removing space 178, the pure water 17 is also provided from each sub-supply tube 180 to the gap C3 at the same time. This supplied pure water 17 from the circumference serves as an embankment of the pure water 17 flowing through the film removing space 178, and prevents the pure water 17 from passing through the gap C3 from the film removing space 178 and leaking to the outside. Therefore, it is possible to prevent the pure water which has passed through the film removing space 178 and been contaminated from coming into contact with any other part on the wafer W.

Although the resist 16 abraded by laser irradiation is removed from the region 14 together with the working liquid (pure water) in the foregoing embodiment, the resist 16 abraded by laser irradiation may be removed from the region 14 by vacuum suction.

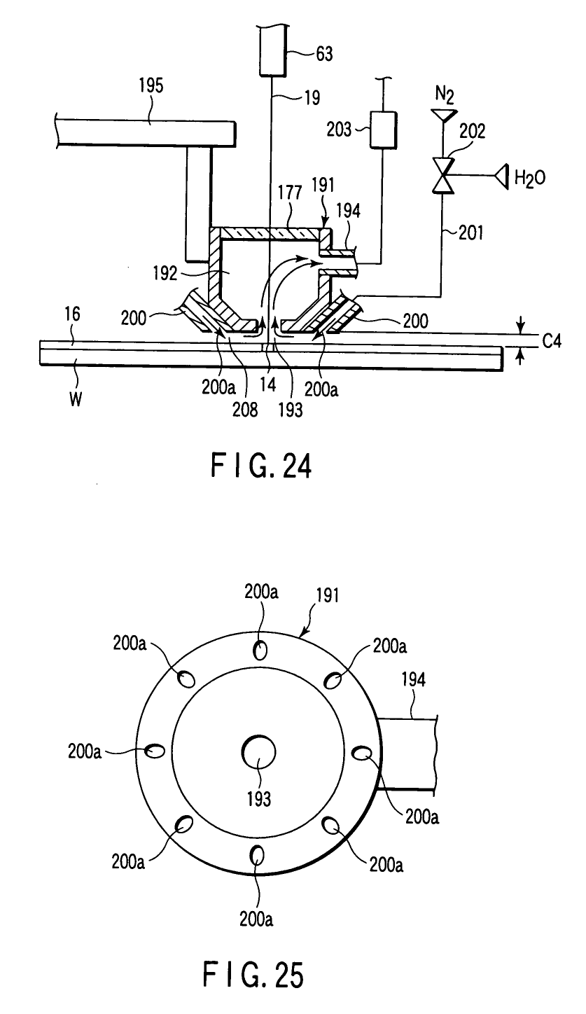

As shown in FIG. 24, a plurality of fluid supply portions 200 may be provided to the lower portion on the side surfaces of the film removing unit 191. The fluid supply portions 200 communicate with a plurality of non-illustrated fluid supply sources so as to selectively supply a gas (e.g., air or an oxygen gas) and a liquid (e.g., pure water) to the vicinity of the film removing region 14. These fluid supply portions 200 have outlets 200a opened on a concentric circle with a suction opening 193 at the center as shown in FIG. 25. In the illustrated case, the outlets 200a are provided at eight positions, but they can be provided at three to 16 positions.

Further, as shown in FIG. 24, each outlet 200a is opened facing the center of the film removing unit 191, and designed to belch out a fluid to a clearance between the film removing unit 191 and the wafer W. Each fluid supply portion 200 communicates with a gas supply source (not shown) and a liquid supply source (not shown) through the supply tube 201.

A three-way valve 202 is attached to the supply tube 201. One upstream opening of this three-way valve 202 communicates with an oxygen gas supply source (not shown), and the other upstream opening of the same communicates with a pure water supply source (not shown). The controller 81 appropriately switches a fluid to be supplied to the film removing unit 191 between the oxygen gas and the pure water by controlling a power supply switch of the three-way valve 202.

On the other hand, an ejector 203 as negative pressure generating means communicates with the discharge tube 194. The controller 81 adjusts a negative pressure to be applied to the discharge tube 194 and adjusts a suction force of the suction opening 193 by controlling a power supply switch of the ejector 203.

When removing the film of the resist 16, the oxygen gas or the pure water is supplied from each fluid supply portion 200 to the vicinity of the film removing region 14. When the oxygen gas is supplied, as shown in FIG. 24, the oxygen gas is sucked into the suction opening 193 together with the abraded resist 16, and discharged from the discharge tube 194 through a discharge chamber 192. As a result, exhaust is smoothly carried out in the vicinity of the film removing region 14, and it is possible to suppress, e.g., the inside of the recovery mechanism 90 from gradually having a negative pressure and a suction pressure of the film removing unit 191 from being reduced.

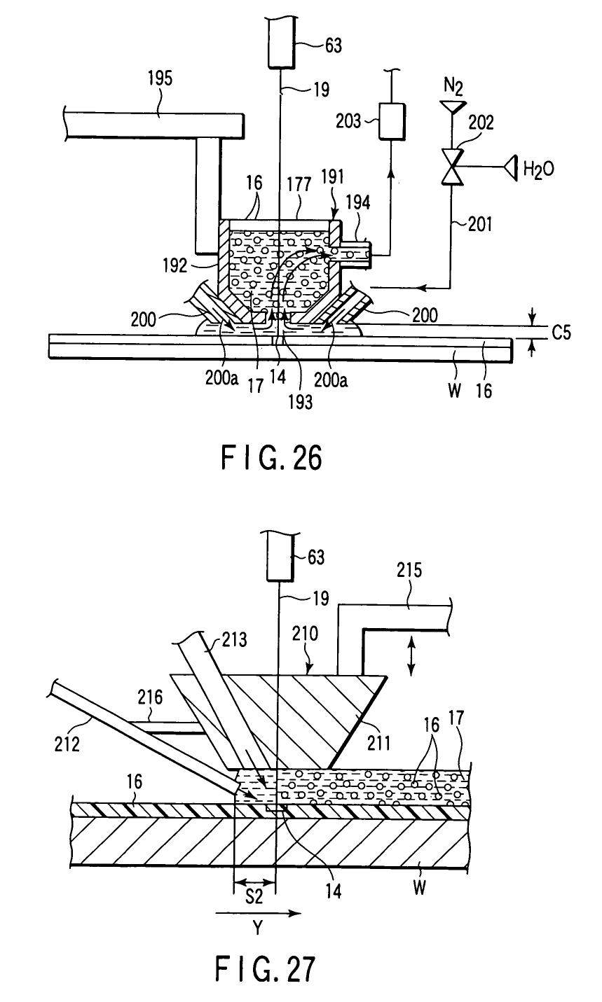

On the other hand, when the pure water is supplied, as shown in FIG. 26, a thin film of the pure water is formed between the film removing unit 191 and the wafer W, and the abraded resist 16 is sucked into the suction opening 193 together with this thin film of the pure water. Furthermore, the pure water is discharged to the outside from the discharge tube 194 through the discharge chamber 192. It is to be noted that a suction quantity from the suction opening 193 may be adjusted and a quantity of the pure water in the gap between the film removing unit 191 and the wafer W may be adjusted by adjusting a pressure of the ejector 203. Moreover, in the film removing apparatus, only the gas may be supplied to the vicinity of the film removing region 14, or only the liquid may be supplied to the vicinity of the film removing region 14.

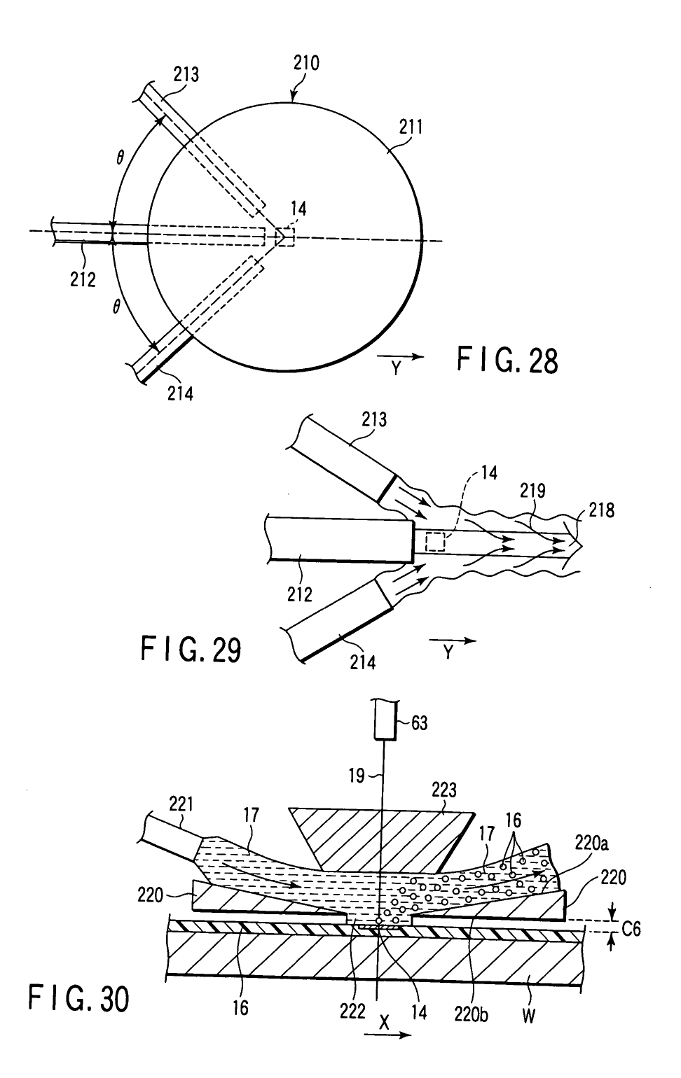

As shown in FIGS. 27 and 28, the abraded resist 16 may be suppressed from again adhering to the wafer W by using a film removing member 210. The film removing member 210 comprises a main body 211, a first nozzle 212 and a pair of right and left second nozzles 213 and 214. The first nozzle 212 is attached to a rear portion of the main body 211 along the axis Y as seen in a horizontal plane, and supplies a liquid from a rear side to the film removing region 14.

As shown in FIG. 28, the second nozzles 213 and 214 are symmetrically arranged on both sides of the first nozzle 212, and they are arranged so as to form an acute angle θ (e.g., θ=5° to 45°) with the first nozzle 212 as seen in a horizontal plane. The liquid can be also supplied from these two second nozzles 213 and 214 to the film removing region 14 obliquely from behind.

The main body 211 has, e.g., a substantially inverted conical shape, and a horizontal surface is formed to an end portion of the circular cone, i.e., the lower portion of the main body 211. The main body 211 is formed of a transparent material such as glass and can transmit the laser beams 19 therethrough. The main body 211 is supported by a holding arm 215 so as to be capable of moving in the respective directions of the axis X, the axis Y and the axis Z. It is to be noted that the holding arm 215 has substantially the same structure as that of the above-described holding arm 85.

As shown in FIG. 27, the main body 211 contains the second nozzles 213 and 214. The second nozzles 213 and 214 respectively communicate with a liquid supply device (not shown). Supply openings of the second nozzles 213 and 214 are opened on the bottom surface of the main body 211, and each of their diameters is, e.g., approximately 2 mm. The controller 81 supplies a command signal to a drive circuit of the liquid supply source, and causes the second nozzles 213 and 214 to emit the liquid with a predetermined timing at a predetermined flow velocity.

The first nozzle 212 is supported by the main body 211 by using a support rod 216. An end portion of the first nozzle 212 is separated from a shaft center of the main body 211 (optical axis of the laser beams 19) rearwards by a small distance S2. The distance S2 is determined as, e.g., approximately 0.01 mm to 0.05 mm. The first nozzle 212 is inclined in a direction of a depression angle of, e.g., approximately 5° to 45° with respect to a horizontal plane. The controller 81 supplies a command signal to the drive circuit of the liquid supply source, and causes the first nozzle 212 to emit the liquid with a predetermined timing at a predetermined flow velocity.

When removing the film, the main body 211 is arranged in contiguity with the wafer W in such a manner that the shaft center of the main body 211 is placed above the film removing region 14. The pure water is emitted from the first nozzle 212 at a flow velocity of, e.g., not less than 20 m/sec. As a result, the pure water is supplied to the film removing region 14 at short range, and a flow of the pure water which advances along the axis Y (first flow 218) is formed as shown in FIG. 29.

On the other hand, the pure water is also emitted from the second nozzles 213 and 214 at a flow velocity slower than that of the pure water from the first nozzle 212. The flow velocity of the pure water from the second nozzles 213 and 214 is determined as, e.g., approximately 1 m/sec. As a result, flows of the pure water (second flows 219) slower than the first flow are formed on both sides of the first flow 218. Since the first flow 218 is faster than the second flows 219, a difference in pressure is generated between the first flow 218 and the second flows 219, and a force directed from the second flows 219 toward the first flow 218 acts. As a result, when the film removing region 14 is irradiated with laser beams and the resist 16 is abraded, the resist is removed from the wafer W with the first flow 218 sandwiched between the second flows 219. Therefore, the abraded resist 16 is not diffused on the surface of the wafer W, and it is suppressed from again adhering to the wafer W.

It is to be noted that there may be provided a recovery mechanism which recovers the liquid of the first flow 218 which has passed at least the film removing region 14.

As shown in FIG. 30, the abraded resist 16 may be suppressed from again adhering to the wafer W by using a mask member 220. In this example, the mask member 220 is arranged between, e.g., a nozzle 221 which supplies a liquid such as pure water onto the wafer W and the wafer W. The entire mask member 220 has a substantially discoid shape with a radius larger than that of the wafer W, and an upper surface 220a of the mask member 220 is inclined in such a manner that a central portion becomes low. A through hole 222 having a diameter of, e.g., approximately 0.5 mm is provided at the central portion of the mask member 220. The lower surface 220b of the mask member 220 is a horizontal surface. The mask member 220 is held by a holding arm (not shown) having the same function as that of the holding arm 85, and can move in the horizontal direction and the vertical direction without restraint.

A guide member 223 which holds and guides the fluid from the upper side is arranged above the through hole 222 of the mask member 220. The guide member 223 is a transparent member formed of, e.g., quartz glass. This guide member 223 has, e.g., a substantially cubical shape. The guide member 223 is held by a holding arm (not shown) movable, e.g., in the vertical direction, and a distance between this arm and, e.g., the upper surface 220a of the mask member 220 can be adjusted to a predetermined distance, e.g., approximately 0.05 mm to 0.3 mm.

Additionally, when removing the film, the mask member 220 and the guide member 223 are moved above the film removing region 14, and the mask member 220 is moved close to the wafer W in such a manner that a distance f between a lower surface 220b of the mask member 220 and the surface of the wafer W becomes, e.g., 10 μm to 100 μm. At this moment, a position of the mask member 220 is adjusted in such a manner that the through hole 222 is placed so as to be opposed to the film removing region 14. Then, a liquid, e.g., pure water is emitted from the nozzle 221 onto the mask member 220, and the emitted pure water flows downward on the upper surface 220a, passes through the through hole 222, flows upward on the upper surface 220a on the opposite side and is drained into, e.g., the cup 61 from the mask member 220. In this state, when the film removing region 14 is irradiated with the laser beams and the resist 16 is abraded, the abraded resist 16 is taken into a flow of the pure water on the mask member 120 and discharged from the surface of the wafer W. As a result, the once removed resist 16 can be suppressed from again adhering to the wafer W.

It is to be noted that the shape of the mask member 220 is not restricted to the discoid shape, and any other shape, e.g., a square shape may be used. Further, the upper surface 220a of the mask member does not have to be inclined, and it may be a horizontal surface.

Although the resist film 16 on the alignment mark 15 existing at the film removing region 14 of the wafer W is removed in the foregoing embodiment, the present invention can be applied to an example in which the film is removed in any other intended use. Furthermore, the substrate is not restricted to the wafer, and any other substrate such as an LCD substrate or a mask reticle substrate for a photomask may be used.

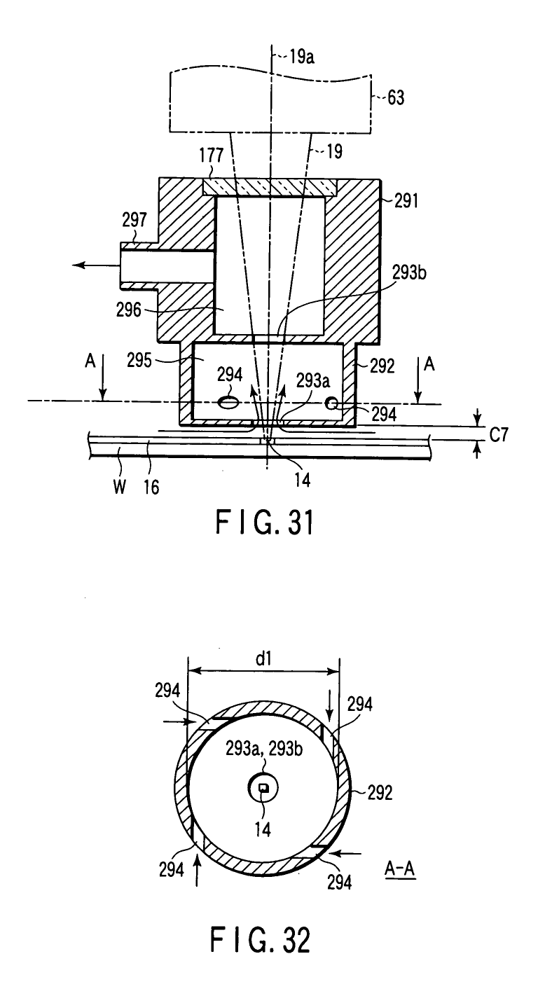

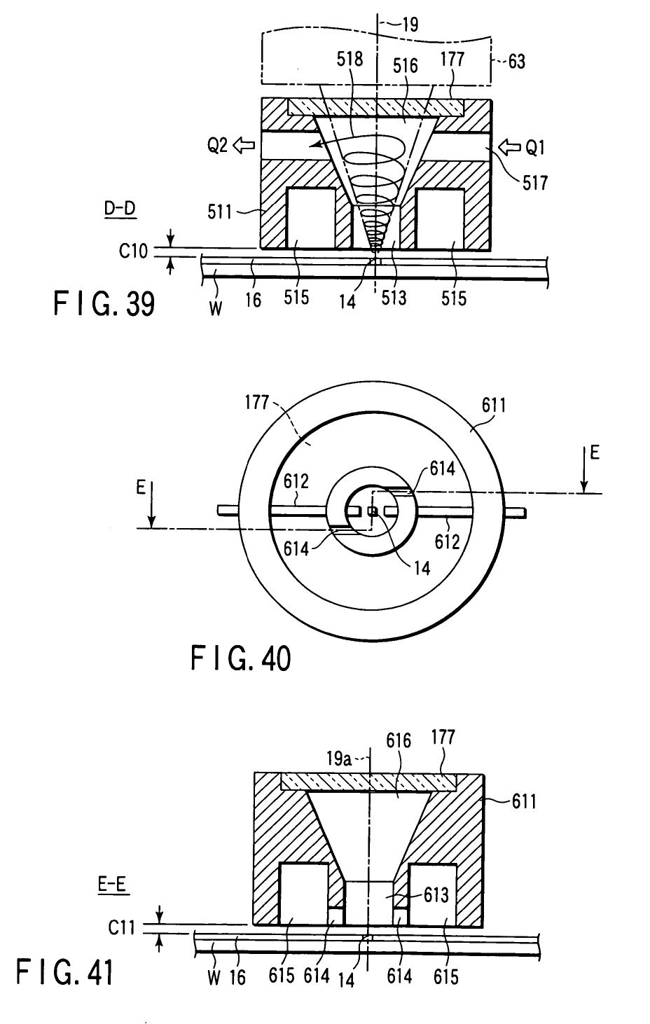

Film removing units according to various embodiments will now be described with reference to FIGS. 31 to 41.

As shown in FIG. 31, two upper and lower cylindrical fluid chambers 295 and 296 are formed in a film removing unit 291 so as not to obstruct a path of the laser beams 19. A non-illustrated vacuum pump communicates with the upper chamber 296 through an exhaust tube 294. The lower chamber 295 as a suction facilitating chamber is formed below the upper chamber 296. Two suction openings 293a and 293b are aligned in series in the vertical direction along a laser optical axis 19a. The second suction opening 293b has a function to suck the abraded resist 16 and the fluid 17 from a laser irradiation area. The first suction opening 293a has a function to further strongly suck the abraded resist 16 and the fluid 17 which have passed through the second suction opening 293b. It is to be noted that a transparent member 177 such as transparent glass is fitted in the upper portion of the film removing unit 291.

As shown in FIG. 32, four third suction openings 294 are formed on a circumferential wall 292 of the lower chamber 295. Each suction opening 294 sucks and introduces a fluid (e.g., air) in a direction deviating from the laser optical axis 19a (direction of a substantial tangential line), and forms an ascending whirling flow of the fluid in the lower chamber 295. The number and a diameter of the third suction openings 294 are optimally selected in accordance with a size of the lower chamber 295 as the suction facilitating chamber. For example, when an inside diameter d1 of the lower chamber 295 is 25 mm, it is preferable to set a diameter of each third suction opening 294 to 2 mm and the number of these openings to two.

It is to be noted that a gap C7 between the film removing unit (suction opening 293a) and the coating film 16 is arbitrarily adjusted in a range of 50 to 1000 μm by highly accurately controlling operations of elevating mechanisms 86 and 87 by the controller 81.

According to the apparatus of this embodiment, since the suction force is intensified by the whirling flow, particles generated in laser irradiation can be all sucked and eliminated.

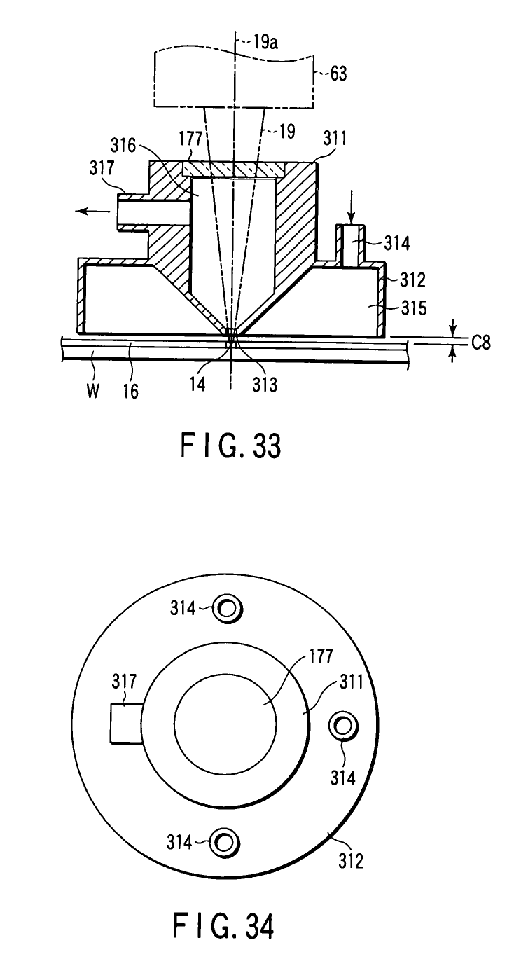

As shown in FIG. 33, a discharge chamber 316 communicating with a suction opening 313 at the lower end and an exhaust tube 317 is formed in the film removing unit 311. Furthermore, a gas purge chamber 312 is attached to the lower portion of the film removing unit 311. This gas purge chamber 312 is provided so as to surround the suction opening 313, and the oxygen gas is supplied from an oxygen gas supply source (not shown) through air supply openings 314. As shown in FIG. 34, the air supply openings 314 communicate with the upper portion of the gas purge chamber 312 at three positions.

It is to be noted that a gap C8 between the film removing unit 311 (suction opening 313) and the coating film 16 is arbitrarily adjusted in a range of 50 to 1000 μm by highly accurately controlling operations of the elevating mechanisms 86 and 87 by the controller 81. Moreover, a supply quantity Q1 of the oxygen gas is adjusted so as to be larger than or equal to a suction exhaust quantity Q2 (Q1≧Q2) by controlling operations of an oxygen gas supply source (not shown) and a vacuum pump (not shown) by using the controller 81.

According to the apparatus of this embodiment, since the suction force is intensified by the whirling flow, particles generated in laser irradiation can be all sucked and eliminated.

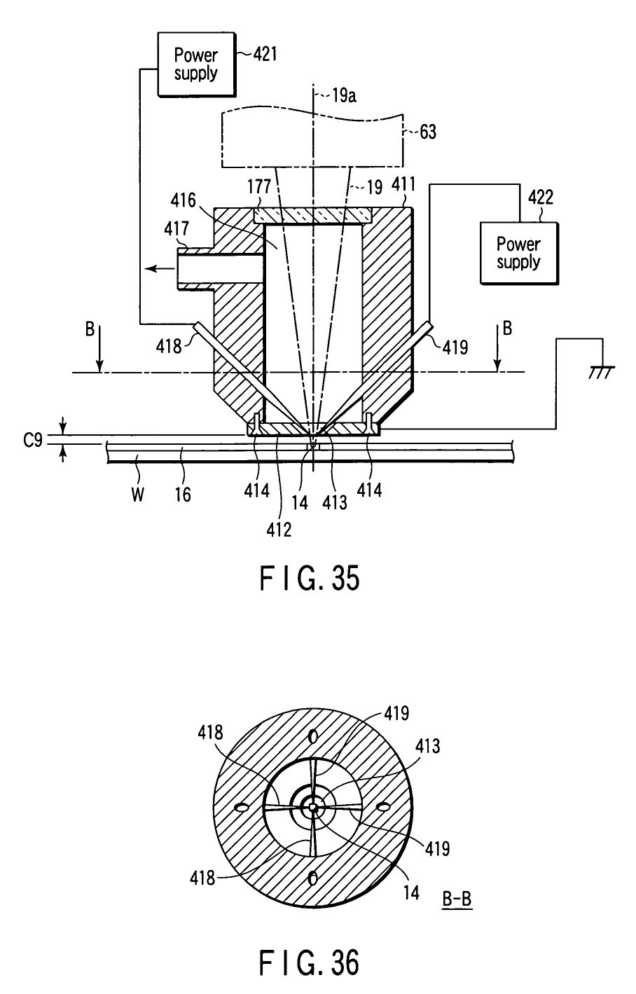

As shown in FIG. 35, a discharge chamber 416 communicating with a suction opening 413 at the lower end and an exhaust tube 417 is formed in the film removing unit 411. The suction opening 413 is formed at the center of a flat plate 412, and the flat plate 412 is detachably attached to the lower portion of the main body of the film removing unit 411 by using a plurality of bolts 414. It is to be noted that the flat plate 412 is formed of an insulative material such as ceramics.

As shown in FIG. 36, two pairs of positive and negative electrodes 418 and 419 are introduced in the discharge chamber 416 through a circumferential wall of the discharge chamber 416. The two pairs of electrodes 418 and 419 opposed to each other are arranged in such a manner that their ends are set close to the suction opening 413 as much as possible. One pair of electrodes 418 are connected to a high-voltage power supply 421, and a positive voltage of several kV is applied. On the other hand, the other pair of electrodes 419 are connected to a power supply 422, and a negative voltage of several kV is applied.

It is to be noted that a gap C9 between the film removing unit 411 (suction opening 413) and the coating film 16 is arbitrarily adjusted in a range of 50 to 1000 μm by highly accurately controlling operations of the elevating mechanisms 86 and 87 by using the controller 81.

According to the apparatus of this embodiment, since charged particles can be sucked to the electrode side, the particles can be prevented from adhering to the wafer W. It is to be noted that the particles which have adhered to the electrodes do not fall onto the wafer W since an ascending air current caused due to suction exists.

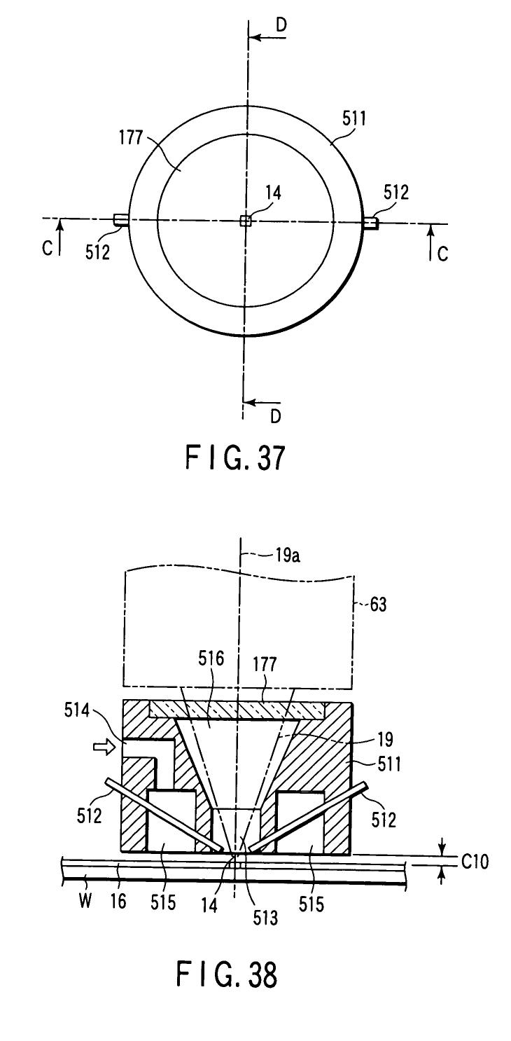

As shown in FIGS. 37 to 39, a discharge chamber 516 communicating with a suction opening 513 at the lower end and an exhaust tube 517 is formed in a film removing unit 511. Moreover, an annular auxiliary fluid chamber 515 is formed so as to surround the suction opening 513. Additionally, two needles 512 are introduced into the discharge chamber 516 through circumferential walls of the discharge chamber 516 and the auxiliary fluid chamber 515. The opposed two needles 512 are arranged in such a manner that their ends are set close to the suction opening 413 as much as possible. It is desirable to set the end of each needle 512 close to the laser irradiation area 14 as much as possible so as not to interfere with a path of the laser beams 19. Each needle 512 has an inner flow path, and the inner flow path is opened at the end of the needle 512. A non-illustrated fluid supply source communicates with the inner flow path. It is to be noted that the discharge chamber 516 has an inverted truncated conical shape (mortar-like shape). Further, an oxygen gas supply source (not shown) communicates with the auxiliary fluid chamber 515 through an air supply opening 514.

A fluid is supplied from the needles 512 at short-time intervals with timings immediately before and immediately after laser irradiation. That is, a fluid (pure water or a gas) is emitted for, e.g., only 0.1 to 0.3 second with a timing of 0.5 second immediately before laser irradiation, and the fluid (pure water or a gas) is emitted for, e.g., only 0.1 to 0.3 second with a timing of 0.5 second immediately after laser irradiation. It is to be noted that the fluid emitted from the needles 512 is the same as the fluid supplied from the nozzle.

The fluid is emitted from needles 418 and 419 for only a very short time before and after processing (0.5 second before processing, and 0.5 second after processing). It is to be noted that only one needle may be used or two needles may be used at the same time. Furthermore, the fluid emitted from the needles may be a liquid (e.g., pure water) or a gas (e.g., air or an oxygen gas).

When the fluid is emitted from the both needles 512, an ascending whirling flow 518 which whirls in a suction chamber 516 is formed. This ascending whirling flow 518 facilitates drainage of the fluid from the suction chamber 516.

It is to be noted that a gap C10 between the film removing unit 511 (suction opening 513) and the coating film 16 is arbitrarily adjusted in a range of 50 to 1000 μm by highly accurately controlling operations of the elevating mechanisms 86 and 87 by using the controller 81.

According to the apparatus of this embodiment, particles generated in the resist abrading processing portion 14 can be smoothly taken into the upper whirling flow by emission of the fluid from the needles 418 and 419. In particular, particles which are to be scattered right beside the processing portion 14 can be effectively sucked and eliminated by a synergistic effect of the needle local fluid emission and the upper whirling flow.

As shown in FIGS. 40 and 41, a discharge chamber 616 communicating with a suction opening 613 at the lower end and an exhaust tube 417 is formed in film removing unit 611. Furthermore, an annular auxiliary fluid chamber 615 is formed so as to surround the suction opening 613. An oxygen gas supply source (not shown) communicates with the auxiliary fluid chamber 615.

Moreover, two needles 612 are introduced into the discharge chamber 616 through circumferential walls of the discharge chamber 616 and the auxiliary fluid chamber 615. The opposed two needles 612 are arranged in such a manner that their ends are set close to the suction opening 613 as much as possible. It is desirable to set an end of each needle 612 close to the laser irradiation area 14 as much as possible so as not to interfere with a path of the laser beams 19.

Slits 614 are formed to a partition wall which partitions the discharge chamber 616 and the auxiliary chamber 615 at two positions, and the oxygen gas flows toward the discharge chamber 616 from the auxiliary fluid chamber 615 through the slits 614.

It is to be noted that a gap C11 between the film removing unit 611 (suction opening 613) and the coating film 16 is arbitrarily adjusted in a range of 50 to 1000 μm by highly accurately controlling operations of the elevating mechanisms 86 and 87 by using the controller 81.

According to the apparatus of this embodiment, since a sufficient quantity of oxygen gas is supplied to the laser irradiation area 14 through the slits 614, the resist film 16 as a abrading target can be readily completely burned, thereby further improving the effect to remove the resist film 16.

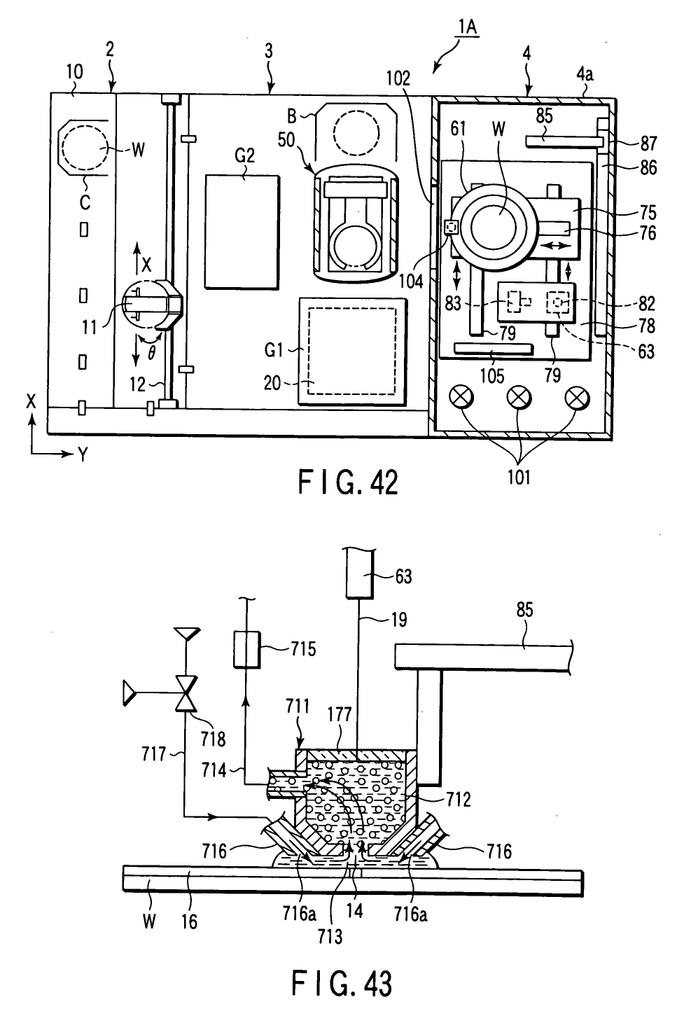

Although shake-off drying is performed by rotating the wafer W wet with the pure water in the foregoing embodiment, the pure water may be removed by emitting a gas to the wafer W. For example, an air knife unit 105 as a gas emission portion is provided on an upper surface of the casing 4a of the film removing apparatus 4. The air knife unit 105 is arranged in a movement range of the wafer W obtained by the X-Y stage 62 as shown in FIG. 42. The air knife unit 105 has a slit-like emission opening longer than, e.g., a diameter of the wafer W, and can emit air with a curtain-like shape to the wafer W provided below. Furthermore, when eliminating the pure water on the wafer W after removing the film, the X-Y stage 62 is driven with air being emitted from the air knife unit 105, and the wafer W is caused to pass under air with the curtain-like shape. By doing so, the pure water remaining on the wafer W is blown away, thereby drying the wafer W.

The above-described air emission step may be performed while rotating the wafer W. Moreover, the air emission step may be effected while vibrating the ultrasonic vibrator 71 attached to the chuck 60. Additionally, the air emission step may be conducted while rotating the wafer W and vibrating the ultrasonic vibrator 71.

Although the abraded antireflection film is removed by causing the fluid such as pure water to flow on the wafer W in the foregoing embodiment, the abraded antireflection film may be eliminated by sucking and draining the fluid existing in the vicinity of the film removing region 14.

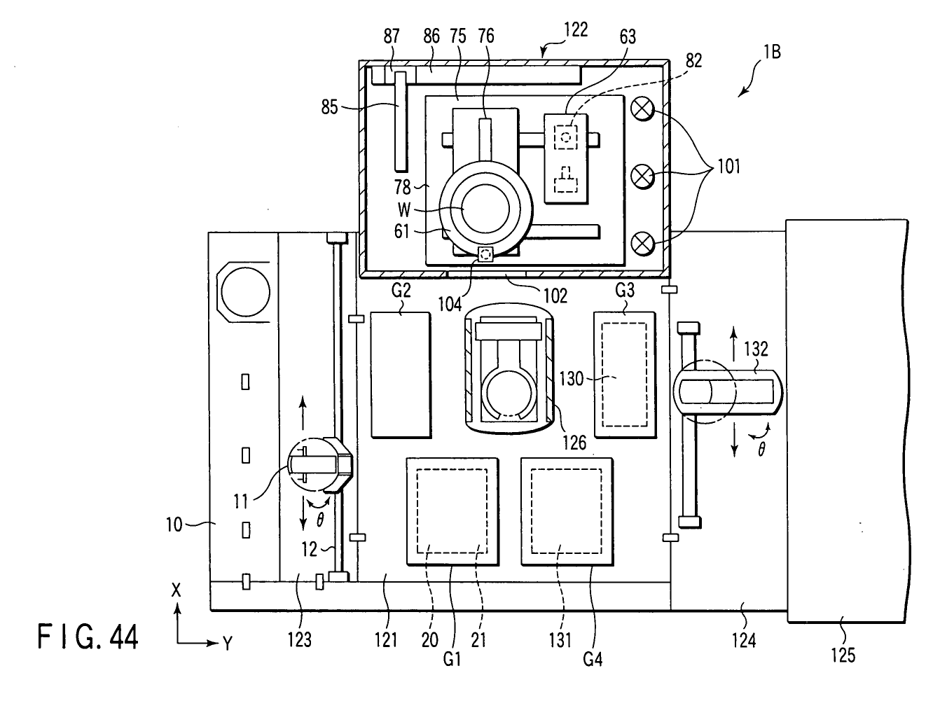

As shown in FIG. 43, to the film removing apparatus 710 is provided a film removing unit 711 which is used to suck and drain a fluid such as an atmosphere in the vicinity of the film removing region 14. The film removing unit 711 is formed into, e.g., a substantially cylindrical shape, and a discharge chamber 712 forming a substantially sealed space is formed inside this unit. A suction opening 713 from which a fluid existing on the lower side is sucked into the discharge chamber 712 is provided on a lower surface of the film removing unit 711. A discharge tube 714 used to discharge the fluid sucked into the discharge chamber 712 is connected to a side surface of the film removing unit 711. The discharge tube 714 is caused to communicate with, e.g., an ejector 715 as negative pressure generating means, and can suck the fluid in the discharge chamber 712 with a predetermined pressure and a predetermined timing. Therefore, the fluid existing below the film removing unit 711 can be sucked from the suction opening 713, caused to pass through the discharge chamber 711 and discharged from the discharge tube 714.

Fluid supply portions 716 which can selectively supply air, a gas such as an oxygen gas and a liquid such as pure water to the vicinity of the film removing region 14 are provided to the lower portions on side surfaces of the film removing unit 711. The plurality of fluid supply portions 716 are provided on the same circumference with the suction opening 713 at the center. Each fluid supply portion 716 is provided on a tilt in such a manner that a supply opening 716a of the fluid supply portion 716 faces the suction opening 713 side. As a result, each fluid supply portion 716 can supply a predetermined fluid to a gap between the film removing unit 711 and the wafer W. Each fluid supply portion 716 is caused to communicate with and connected with a supply source (not shown) of a gas, e.g., an oxygen gas and a supply source of a liquid, e.g., pure water through, e.g., a supply tube 717. To the supply tube 717 is provided, e.g., a three-way valve 718, and supply of the oxygen gas and the pure water can be appropriately switched by using this three-way valve 718. It is to be noted that the switching operation of the three-way valve 718 is controlled by the controller 81.

An upper portion of the film removing unit 711, i.e., an upper surface of the discharge chamber 712 is formed of a transparent member 177 such as quartz glass. The suction opening 713 is arranged below the transparent member 177 with the discharge chamber 712 therebetween, and the laser beams emitted from above can be transmitted through the transparent member 177, the discharge chamber 712 and the suction opening 713, and the wafer W provided below can be irradiated with the laser beams.

The film removing unit 711 is held by, e.g., the holding arm 85, and the suction opening 713 can be arranged above the film removing region 14 of the wafer W. Furthermore, a height of the film removing unit 711 can be adjusted, and a distance between the suction opening 713 and the wafer W can be set to an optimum distance, e.g., approximately 10 to 50 μm.

Moreover, when removing the film, the film removing unit 711 moves above the film removing region 14. The pure water is supplied from the fluid supply portion 716 to, e.g., the vicinity of the film removing region 14, and the pure water is sucked from the suction opening 713. The pure water sucked from the suction opening 713 passes through a hollow portion 712, and is drained through the discharge tube 714. In this manner, with a flow of the pure water flowing through the fluid supply portion 716, the film removing region 14, the suction opening 713 and the discharge tube 714 in the mentioned order being formed, the laser beams are emitted from the laser oscillator 63, and the film removing region 14 is irradiated with the laser beams transmitted through the transparent member 177 and the suction opening 713. The antireflection film abraded by this irradiation is taken into the flow of the pure water, and discharged through the film removing unit 711. When irradiation of the laser beams is terminated, supply and drain of the pure water are continued for a predetermined time, and they are stopped thereafter.

According to the apparatus of this embodiment, the antireflection film abraded from the wafer W by the laser beams is immediately sucked from the suction opening 713, and discharged. Therefore, the abraded antireflection film can be prevented from again adhering to the wafer W, thereby avoiding contaminations of the wafer W. Since the upper surface of the film removing unit 711 is formed of the transparent member and the inside of the film removing unit 711 is hollow, the laser beams can be emitted in a state that the film removing unit 711 is arranged directly above the film removing region 14. Therefore, suction can be performed with the suction opening 713 being moved to the film removing region 14 as much as possible. In particular, since it has been confirmed from experiments or the like that particles of the antireflection film abraded from the wafer W float upwards, the advantage is large. It is to be noted that the pure water is supplied from the fluid supply portion 716 in this example, a gas such as an oxygen gas may be supplied. In such a case, since an air current which passes through the film removing region 14 and is sucked from the suction opening 713 is formed, the antireflection film abraded from the wafer W can be rapidly and assuredly removed.

In the above-described embodiment, after the antireflection film is formed, the film removing processing is carried out and the resist film is then formed. However, the resist film may be formed after forming the antireflection film, and then the film removing processing may be conducted depending on each recipe. In such a case, the wafer W having the antireflection film formed by the antireflection film forming device 20 is heated and cooled, and then carried to the resist applying device 21 where the resist film is formed on the wafer W. Thereafter, the wafer W is heated and cooled, and then carried to the film removing apparatus 4. The wafer W subjected to the film removing processing in the film removing apparatus 4 is heated and cooled, and thereafter returned to the cassette station 2 from the extension device 43.

Further, although the resist applying device 21 is provided to the processing station 3 in the substrate processing system 1 according to the foregoing embodiment, the resist applying device 21 may not be provided. In this case, the antireflection film is formed on the wafer W, and then the film at the film removing region 14 is removed. Thereafter, the wafer W is returned to the cassette station 2 from the extension device 43.

Furthermore, as shown in FIG. 44, the system described in conjunction with the foregoing embodiment may include an interface portion 124 having a carriage device which carries the wafer W between the processing station and the exposure device.

As shown in FIG. 44, the film removing apparatus 122 is provided on the rear surface side (upper side in FIG. 14) of the processing station 121 in the processing system 1B. It is to be noted that the film removing apparatus 122 has the same structure as that of the above-described film removing apparatus 4, for example. The cassette station 123 and the interface portion 124 are provided on the both sides with the processing station 121 therebetween. Moreover, the exposure device 125 is provided so as to be adjacent to the interface portion 124 outside this system.

A third processing device group G3 is provided to the processing station 121 on the interface portion 124 side of the main carriage device 126. The third processing device group G3 includes an extension device 130 as a delivery portion to deliver the wafer W to the interface portion 124 side. Furthermore, a fourth processing device group G4 is provided on the front side of the main carriage device 126. For example, two stages of development processing devices 131 are provided to the fourth processing device group G4 in the overlapping manner. It is to be noted that an antireflection film forming device 20 and a resist applying device 21 are provided to the first processing device group G1 like the first embodiment, and cooling devices 40 to 42, an extension device 43 and heating processing devices 44 to 46 are provided to the second processing device group G2.

The main carriage device 126 is arranged so as to be capable of carrying the wafer W to the film removing apparatus 112, the third processing device group G3 and the fourth processing device group G4 in addition to the first processing device group G1 and the second processing device group G2. It is to be noted that any other processing devices such as a cooling device or a heating processing device as well as the extension device 130 may be provided to the third processing device G3 in accordance with a recipe of the wafer W.

A wafer carrier 132 as a carriage device is provided to the interface portion 124. This wafer carrier 132 is configured so as to be movable in an direction of an axis X (up-and-down direction in FIG. 14) and a direction of Z (vertical direction) and rotatable in a direction 0 (rotational direction around an axis Z). It accesses the extension device 130 and the exposure device 125 of third processing device group G3 and can carry the wafer W to each of these members.

Moreover, when processing the wafer W, the wafer W is delivered to the main carriage device 126 from the cassette station 123 through the extension device 43, and the main carriage device 126 carries the wafer W to the antireflection film forming device 20. When the antireflection film is formed on the wafer W, the wafer W is heated and cooled, and then carried to the film removing apparatus 122 by the main carriage device 126. Additionally, the wafer W subjected to the film removing processing described in conjunction with the foregoing embodiment is heated and cooled, and then carried to the resist applying device 21 The wafer W subjected to the resist application processing in the resist applying device 21 is heated and cooled, and then carried to the extension device 130 of the third processing device group G3. It is further carried to the exposure device 125 by the wafer carrier 132. The wafer W subjected to exposure processing in the exposure device 125 is returned to the extension device 130 by the wafer carrier 132. The wafer W returned to the extension device 130 is heated and cooled, and then carried to the development processing device 131. After performing the development processing of the wafer W in the development processing device 131, the wafer W is again heated and cooled, and then carried to the extension device 43 of the second processing device group G2 by the main carriage device 126. Subsequently, the wafer W is returned to the cassette C of the cassette station 123 by the sub-arm carriage mechanism 11, thereby terminating a series of processing of the wafer W.

As described above, by providing the interface portion 124 which carries the wafer W between the processing station 121 and the development device 125, a series of wafer processing conducted in the order of the antireflection film formation, the film removing processing, the resist film formation, the exposure processing and the development processing can be effected in one processing system. Therefore, since an operator or the like does not carry the wafer W during processing, the wafer W can be prevented from being contaminated or damaged. Further, since a carriage time or the like of the wafer W can be reduced, an entire processing time of the wafer W can be also decreased.

It is to be noted that the film removing apparatus 122 is arranged on the rear surface side of the processing station 121 in the foregoing embodiment, it may be provided on the other side surface if it is a position where the main carriage device 126 can have access. The interface portion 124 may be likewise provided on the other side surface of the processing station 121. Furthermore, a buffer cassette which causes the wafer W to temporarily enter the standby mode before carriage of the film removing apparatus 112 may be provided in the processing station 121.

Although the above-described embodiment removes the antireflection film, the present invention can be also applied to a case in which the antireflection film and the resist film are simultaneously removed, for example. Moreover, the present invention can be applied to a case in which another film is removed. It is to be noted that contents or orders of processing other than the above-described film removing processing can be arbitrarily changed in accordance with a recipe of the wafer. Additionally, the substrate is not restricted to the wafer, and it may be any other substrate such as an LCD substrate or a mask reticle substrate for a photomask.

According to the present invention, since a substrate is not contaminated even if the film on the substrate is removed, the substrate can be maintained in a clean state, and a substrate with the high quality can be manufactured by the subsequent processing.

According to the present invention, contamination of the substrate can be avoided, and the quality of the substrate can be improved. Further, carriage time can be reduced, and throughput can be improved.

What is claimed is:

1. A film removing apparatus comprising:
a substrate holding portion which holds a substrate having a coating film;
a laser source which locally irradiates a predetermined region of the substrate on the substrate holding portion with laser beams, and partially abrades the coating film from the substrate;
a fluid supply mechanism which includes a main nozzle which supplies a predetermined fluid to the predetermined region;
a recovery mechanism having a suction opening which sucks and removes the predetermined fluid supplied to the predetermined region together with an abraded film component on the substrate;
a guide member which has a groove to guide the predetermined fluid emitted from the main nozzle to the predetermined region, and guides the predetermined fluid and the abraded film component to the suction opening of the recovery mechanism so as not to be diffused/leaked around the predetermined region; and
means for locating the guide member in the vicinity of the predetermined region.

2. The apparatus according to claim 1, wherein at least a part of the guide member is formed of a transparent member which can transmit laser beams emitted from the laser source therethrough.

3. The apparatus according to claim 1, further comprising an ultrasonic vibrator attached to the main nozzle.

4. The apparatus according to claim 1, further comprising an ultrasonic vibrator attached to the guide member.

5. The apparatus according to claim 1, further comprising an ultrasonic vibrator attached to the substrate holding portion.

6. The apparatus according to claim 3, wherein the nozzle has an outlet from which the predetermined fluid is directly sprayed toward the predetermined region.

7. The apparatus according to claim 1, further comprising a rectifying plate which is arranged directly above the substrate on the downstream side away from the predetermined region and moves the predetermined fluid from the substrate.

8. The apparatus according to claim 1, further comprising a pair of sub-nozzles provided on both sides of the main nozzle.

9. The apparatus according to claim 8, wherein the fluid supply mechanism supplies a liquid to each of the main nozzle and the sub-nozzles, and
the sub-nozzles emit the liquid in substantially the same direction as a direction along which the main nozzle emits the liquid.

10. The apparatus according to claim 8, wherein the fluid supply mechanism supplies a liquid to the main nozzle and supplies a gas to the sub-nozzles, and
the sub-nozzles emit the gas in substantially the same direction as a direction along which the main nozzle emits the liquid.

11. The apparatus according to claim 7, wherein the suction opening of the recovery mechanism is provided above the rectifying plate.

12. A film removing apparatus comprising:
a substrate holding portion which holds a substrate having a coating film;
a laser source which locally irradiates a predetermined region of the substrate on the-substrate holding portion with laser beams and partially abrades the substrate from the coating film;
a film removing unit which includes a main nozzle which supplies a predetermined fluid to the predetermined region, includes a first suction opening which sucks and removes the predetermined fluid supplied to the predetermined region together with an abraded film component on the substrate, guides the predetermined fluid emitted from the main nozzle to the predetermined region, and guides the predetermined fluid and the abraded film component to the first suction opening so as not to be diffused/leaked around the predetermined region;
a fluid supply mechanism which supplies the predetermined fluid to the main nozzle;
a recovery mechanism to communicate with the first suction opening which opens at a center of a lower surface of the film removing unit;
a discharge chamber which communicates with the recovery mechanism; and
a plurality of main nozzles which are attached to a rim of a lower surface of the discharge chamber and each of which supplies the fluid from the fluid supply mechanism.

13. The apparatus according to claim 12, wherein the film removing unit further has an auxiliary nozzle which is provided on the outer side away from the main nozzle and supplies a liquid to a clearance formed between the film removing unit and the substrate.

14. The apparatus according to claim 12, wherein at least a part of the film removing unit is formed of a transparent member which can transmit laser beams emitted from the laser source therethrough, and
the laser beams are transmitted through the transparent member, and the predetermined region is irradiated with the laser beams after the laser beams pass through the first suction opening.

15. The apparatus according to claim 12, wherein each of the plurality of main nozzles is opened on a concentric circle with the first suction opening at the center.

16. The apparatus according to claim 12, wherein the film removing unit further has:
a suction facilitating chamber which communicates with the discharge chamber through the first suction opening, and facilitates suction of the predetermined fluid and the abraded film component into the discharge chamber;
a second suction opening which is arranged so as to be opposed to the first suction chamber, and opened at the center of a lower surface of the suction facilitating chamber; and
a plurality of third suction openings each of which is opened on a circumferential wall of the suction facilitating chamber so as to face a direction deviating a laser optical axis, causes outside air led into the suction facilitating chamber by suction of the recovery mechanism to whirl in the suction facilitating chamber, and produces a whirling flow of the outside air in the suction facilitating chamber.

17. The apparatus according to claim 12, wherein the film removing unit further has:
a gas purge chamber which surrounds the first suction opening, has a gas supply opening communicating with the fluid supply mechanism, and forms a circumference of the first suction opening as an atmosphere of the predetermined air.

18. The apparatus according to claim 17, wherein the gas purge chamber is formed around the first suction opening in an annular form, and
the plurality of gas supply openings are provided, and each of them is opened at an upper portion of the gas purge chamber.

19. The apparatus according to claim 17, further comprising:
controlling means for controlling the fluid supply mechanism and the recovery mechanism in such a manner that a supply quantity of the predetermined gas supplied from the fluid supply mechanism into the gas purge chamber through the gas supply openings becomes larger than an exhaust quantity of the predetermined gas exhausted from the discharge chamber to the recovery mechanism.

20. The apparatus according to claim 12, wherein the film removing unit further has:
at least a pair of positive and negative electrodes having end portions oppositely arranged in contiguity with the predetermined region;
a first high-voltage power supply which applies a plus voltage to the positive electrode; and
a second high-voltage power supply which applies a minus voltage to the negative electrode.

21. The apparatus according to claim 12, wherein the film removing unit further has:
at least a pair of needles which have end portions oppositely arranged in contiguity with the predetermined region, communicate with the fluid supply mechanism, and have inner flow paths opened at the end portions;
an auxiliary fluid chamber which is formed around the end portions of the needles and communicates with the fluid supply mechanism;
a discharge chamber which is provided above the end portions of the needles and formed into a mortar-like shape; and
a slit which is opened and formed on a partition wall which partitions the auxiliary fluid chamber and the discharge chamber, and causes the auxiliary fluid chamber to communicate with the discharge chamber.

22. The apparatus according to claim 12, further comprising:
an elevating mechanism which supports the film removing unit so as to be capable of moving up and down; and
controlling means for controlling the elevating means in such a manner that a gap between the first suction opening and the coating film above the predetermined region falls within a range of 50 to 1000 μm.

23. The apparatus according to claim 12, further comprising:
a pair of sub-nozzles which are arranged on both sides of the main nozzle, and emit the predetermined fluid in a direction crossing the fluid emitted from the main nozzle at the predetermined region; and
controlling means for controlling the fluid supply mechanism in such a manner that an emission velocity of the predetermined fluid of the main nozzles becomes higher than that of the sub-nozzles.

24. The apparatus according to claim 12, further comprising:
a mask portion which is provided between the substrate and the main nozzle, and on which the predetermined fluid emitted from the main nozzle is guided; and
a through hole which vertically pierces the mask member in such a manner that the predetermined fluid flowing on the mask member comes into contact with the coating film at the predetermined region.

25. The apparatus according to claim 24, wherein the mask member has a lower surface which is substantially horizontally formed and an upper surface which is inclined with respect to the horizontal plane in such a manner a position of the through hole becomes lowest.

26. The apparatus according to claim 24, wherein the mask member has a circular shape as seen in a horizontal plane, and the through hole is formed at the center thereof.

27. The apparatus according to claim 24, further comprising:
a guide member which is formed of a transparent member which transmits laser beams from the laser source therethrough to the predetermined region, arranged above the mask member, opposed to the through hole, and restricts a flow of the predetermined fluid on the mask member; and
an elevating mechanism which supports the guide member so as to be capable of moving up and down.

28. A film removing method comprising:
(a) substantially horizontally holding a substrate in such a manner that a coating film is placed on an upper side, emitting a predetermined fluid onto the substrate from a main nozzle, supplying the predetermined fluid to a predetermined region of the substrate by using a guide member, sucking the predetermined fluid existing at the predetermined region or the predetermined fluid which has passed the predetermined region from a suction opening, and recovering it from the substrate; and
(b) locally irradiating the predetermined region with laser beams with the predetermined fluid being caused to flow, partially abrading the coating film from the substrate, sucking and removing an abraded film component together with the predetermined fluid on the substrate by using the suction opening, and applying ultrasonic waves to the predetermined fluid passing the predetermined region.

29. The method according to claim 28, wherein the step (b) has irradiating the predetermined region with laser beams while forcibly exhausting in the vicinity of the predetermined region.

30. The method according to claim 28, wherein the step (a) has providing a mask member which covers the substrate except the predetermined region and preventing the film component abraded by irradiation of laser beams from adhering to the substrate.

31. The method according to claim 28, wherein the step (b) has opposing the suction opening to the predetermined region, arranging the plurality of main nozzles around the suction opening, sucking the abraded film component together with the predetermined fluid by using the suction opening while supplying the predetermined fluid toward the predetermined region from the plurality of main nozzles, and removing the abraded film from the substrate.

32. The method according to claim 28, wherein the step (b) has providing a pair of right and left sub-nozzles on both sides of the main nozzle, and emitting the predetermined fluid from the sub-nozzles in parallel with the predetermined fluid emitted from the main nozzle.

33. The method according to claim 28, wherein the step (b) has arranging a pair of right and left sub-nozzles on both sides of the main nozzles, and
controlling an emission velocity of the predetermined fluid of the main nozzle to be higher than that of the sub-nozzles when emitting the predetermined fluid from the sub-nozzles in a direction crossing the fluid emitted from the main nozzle at the predetermined region.

34. The method according to claim 28, wherein the step (b) has setting a supply quantity of the predetermined gas supplied from a fluid supply mechanism into a gas purge chamber through a gas supply opening so as to be larger than an exhaust quantity the predetermined gas exhausted from a discharge chamber to a recovery mechanism.

35. The method according to claim 28, wherein the step (b) has positioning the suction opening with respect to the substrate in such a manner that a clearance between the suction opening and the coating film above the predetermined region falls within a range of 50 to 1000 μm.

36. A substrate processing system comprising: a substrate carry-in-and-out portion; a processing portion including a film forming apparatus and a film removing apparatus; and a carriage mechanism which carries a substrate between the film forming apparatus and the film removing apparatus,
wherein the film removing apparatus comprises:
a substrate holding portion which holds a substrate having a coating film;
a laser source which locally irradiates a predetermined region of the substrate on the substrate holding portion with laser beams, and partially abrades the coating film from the substrate;
a fluid supply mechanism including a main nozzle which supplies a predetermined fluid to the predetermined region;
a recovery mechanism having a suction opening which sucks and removes the predetermined fluid supplied to the predetermined region together with an abraded film component on the substrate;
a guide member which guides the predetermined fluid emitted from the main nozzle to the predetermined region and guides the predetermined fluid and the abraded film component to the suction opening of the recovery mechanism so as not to be diffused/leaked around the predetermined region; and
means for supplying a gas to a rim portion of a rear surface of the substrate held by the substrate holding portion.

37. The system according to claim 36, wherein the processing portion comprises: a first film forming apparatus forming a first film on the substrate; and a second film forming apparatus which forms a second film on the substrate, and
the carriage mechanism carries the substrate between the first film forming apparatus, the second film forming apparatus and the film removing apparatus.

38. The system according to claim 36, wherein the processing portion further comprises a heat treatment device which is used to perform a heat treatment to the substrate, and
the carriage mechanism carries the substrate between the heat treatment device, the film forming apparatus and the film removing apparatus.

39. The system according to claim 36, further comprising an interface portion which is provided between an external exposure device and the processing portion, and includes a carriage device which carries the substrate between the exposure device and the processing portion.

40. The system according to claim 36, wherein the film removing apparatus further has:
an elevating mechanism which supports the film removing unit so as to be capable of moving up and down; and
controlling means for controlling the elevating mechanism in such a manner that a clearance between the suction opening and the coating film above the predetermined region falls within a range of 50 to 1000 μm.

41. The system according to claim 36, wherein at least a part of the guide member is formed of a transparent member which can transmit laser beams therethrough.

42. The system according to claim 40, wherein the film removing apparatus further has a gas emission portion which supplies a gas to the coating film on the substrate.

43. The system according to claim 40, further comprising:
an elevating mechanism which supports the film removing unit so as to be capable of moving up and down; and
controlling means for controlling the elevating mechanism in such a manner that a gap between the first suction opening and the coating film above the predetermined region falls within a range of 50 to 1000 μm.

44. A substrate processing system comprising:
a substrate carry-in-and-out portion; a processing portion including a film forming apparatus and a film removing portion; and a carriage mechanism which carries the substrate between the film forming apparatus and the film removing portion,
wherein the film removing apparatus comprises:
a substrate holding portion which holds the substrate having a coating film;
a laser source which irradiates a predetermined region of the substrate on the substrate holding portion with laser beams, and partially abrades the coating film from the substrate;
a film removing unit which includes a main nozzles supplying a predetermined fluid to the predetermined region, includes a first suction opening which sucks and removes the predetermined fluid supplied to the predetermined region together with an abraded film component on the substrate, guides the predetermined fluid emitted from the main nozzle to the predetermined region, and guides the predetermined fluid and the abraded film component to the first suction opening so as not to be diffused/leaked around the predetermined region;
a fluid supply mechanism which supplies the predetermined fluid to the main nozzle; and
a recovery mechanism which communicates with the first suction opening.

45. The system according to claim 44, wherein the film removing apparatus further has:
an elevating mechanism which supports the film removing unit so as to be capable of moving up and down; and
controlling means for controlling the elevating mechanism in such a manner that a gap between the suction opening and the coating film above the predetermined region falls within a range of 50 to 1000 μm.

46. The system according to claim 44, wherein the film removing apparatus further has a movement mechanism which moves the substrate holding portion in a horizontal direction.

47. The system according to claim 44, wherein the film removing apparatus further has a position detection member which detects a position of the substrate held by the substrate holding portion.

48. The system according to claim 44, wherein the film removing apparatus further has a cup which surrounds the outer side of the substrate held by the substrate holding portion.

49. The system according to claim 44, wherein the main nozzle has an outlet arranged in contiguity with the predetermined region on the substrate, and directly supplies the predetermined fluid toward the predetermined region from the outlet.

50. The system according to claim 44, further comprising an air-conditioning device which forms a descending flow of clean air in the film removing apparatus.
